(19) United States
(12) Patent Application Publication
(10) Pub. No.: US 2022/0222093 A1
(43) Pub. Date: Jul. 14, 2022

(54) USER INTERFACE FOR A TOUCH SCREEN DEVICE IN COMMUNICATION WITH A PHYSICAL KEYBOARD

(71) Applicant: Apple Inc., Cupertino, CA (US)

(72) Inventors: Julian MISSIG, Redwood City, CA (US); Morgan WINER, Sunnyvale, CA (US); Jeffrey Traer BERNSTEIN, San Francisco, CA (US)

(21) Appl. No.: 17/709,243

(22) Filed: Mar. 30, 2022

Related U.S. Application Data
(63) Continuation of application No. 16/358,453, filed on Mar. 19, 2019.
Application No. 16/358,453 is a continuation of application No. 15/057,835, filed on Mar. 1, 2016, now abandoned.
(60) Provisional application No. 62/200,993, filed on Aug. 4, 2015.

(51) Int. Cl. G06F 9/451; G06F 3/0485; G06F 8/38; G06F 3/01; G06F 3/04883; G06F 8/34

(52) U.S. Cl. CPC G06F 9/451; G06F 3/0485; G06F 8/38; G06F 2203/04806; G06F 3/04883; G06F 8/34; G06F 2203/014; G06F 3/016

(57) ABSTRACT

The present disclosure relates to user interfaces for viewing, creating, editing, and sharing content on an electronic device. In accordance with some embodiments, a shortcut hint user interface is displayed in response to detection of a downstroke input of a modifier key. The shortcut hint user interface includes information identifying shortcuts associated with the modifier key.

### CROSS-REFERENCE TO RELATED APPLICATIONS

This application is a continuation of U.S. patent application Ser. No. 16/358,453, entitled “USER INTERFACE FOR A TOUCH SCREEN DEVICE IN COMMUNICATION WITH A PHYSICAL KEYBOARD,” filed Mar. 19, 2019, which is a continuation of U.S. patent application Ser. No. 15/057,835, entitled “USER INTERFACE FOR A TOUCH SCREEN DEVICE IN COMMUNICATION WITH A PHYSICAL KEYBOARD,” filed Mar. 1, 2016, which claims the benefit of U.S. Provisional Application No. 62/200,993, filed Aug. 4, 2015, the content of which are incorporated by reference herein in their entirety.

### FIELD

The present disclosure relates generally to computer user interfaces, and more specifically to techniques and user interfaces for a touch screen device in communication with a keyboard.

### BACKGROUND

Many modern electronic devices, such as smartphones, tablet computers, and the like, include a touch-sensitive display, or touch screen, that serves as the primary user interface for the device. The size of the display on such devices is often small, which makes certain tasks (e.g., viewing content and composing documents containing significant amounts of text or other content) difficult to perform.

Some techniques for performing tasks involving viewing, creating, editing, or sharing content using electronic devices are generally cumbersome and inefficient. For example, existing techniques use a complex and time-consuming user interface, which may include multiple key presses or keystrokes. Existing techniques require more time than necessary, wasting user time and device energy. This latter consideration is particularly important in battery-operated devices.

Accordingly, there is a need for electronic devices with faster, more efficient methods and interfaces for performing a larger variety of tasks using a touch screen device. The methods and interfaces described below optionally complement or replace other methods for performing tasks such as viewing, creating, editing, and sharing content, for example. Such methods and interfaces reduce the cognitive burden on a user and produce a more efficient human-machine interface. For battery-operated computing devices, such methods and interfaces conserve power and increase the time between battery charges.

### BRIEF SUMMARY

In accordance with some embodiments, a computer-implemented method includes, at a device with a display: detecting a plurality of discrete inputs that includes a first input followed by a second input; and in response to detecting the plurality of discrete inputs, performing a sequence of operations that includes a first operation that corresponds to the first input followed by a second operation that corresponds to the second input. Performing the sequence of operations includes: in accordance with a determination that the plurality of discrete inputs meets an output-acceleration criteria, the first operation is performed with a first magnitude and the second operation is performed with a second magnitude that is greater than the first magnitude, and in accordance with a determination that the plurality of discrete inputs does not meet the output-acceleration criteria, the first operation and the second operation are performed with the same magnitude.

In accordance with some embodiments, a computer-implemented method includes, at a device with a display: while a user interface is displayed on the display, detecting a stationary input; in response to detecting the stationary input, translating one or more elements of the user interface in accordance with the stationary input; and after translating the one or more elements of the user interface in accordance with the stationary input, detecting an end of the stationary input. The method further includes, after detecting the end of the stationary input and in accordance with a determination that the stationary input meets translation-continuation criteria, continuing to translate the one or more elements of the user interface.

In accordance with some embodiments, a computer-implemented method includes, at a device with a display and in communication with a physical keyboard: detecting, while the device is displaying an active application, an activation of a key on the keyboard, and, in response to detecting the activation of the key, determining whether the device is operating in a first context or a second context. The method further includes, in accordance with a determination that the device is operating in the first context: displaying, on the display, representations of one or more content-sharing application; while displaying the representations of the one or more content-sharing applications, receiving a first user input selecting a first content-sharing application of the one or more content-sharing applications; and in response to receiving the first user input selecting the first content-sharing application, providing data from the application to the first content-sharing application. The method further includes, in accordance with a determination that the device is operating in the second context: displaying, on the display, representations of one or more content-viewing applications, and, while displaying the representations of the one or more content-viewing applications, receiving a second user input selecting a first content-viewing application of the one or more content-viewing applications. The method further includes, in response to receiving the second user input selecting the first content-viewing application, displaying, on the display, representations of one or more content items, where the one or more content items are associated with the first content-viewing application.

In accordance with some embodiments, a computer-implemented method includes, at a device with a display and in communication with a physical keyboard: detecting an activation of a key on the keyboard; and in response to detecting the activation of the key: determining whether the device is operating in a first context or a second context, where electronic content is displayed in the second context. The method further includes: in accordance with a determination that the device is operating in the first context, adjusting a volume level associated with the context; and in accordance with a determination that the device is operating in the second context, adjusting a zoom factor of the electronic content displayed in the second context.

In accordance with some embodiments, a computer-implemented method includes, at a device with a display and in communication with a physical keyboard, detecting an activation of a key on the physical keyboard and determining whether the activation of the key represents a first activation input or a second activation input. The method further includes: in accordance with a determination that the activation of the key represents the first activation input, preparing to receive a text input; and in accordance with a determination the activation of the key represents the second activation input, preparing to receive a voice input.

In accordance with some embodiments, a computer-implemented method includes, at a device with a display and in communication with a physical keyboard: detecting a downstroke input for each key in a set of one or more keys on the keyboard, the set of one or more keys including a modifier key that is associated with a plurality of context dependent operations and a plurality of shortcut operations associated with keys on the keyboard; and, after detecting the downstroke input for each key in the set of one or more keys, detecting an upstroke input for a respective key in the set of one or more keys. The method further includes, in response to detecting the upstroke input for the respective key: in accordance with a determination that the set of one or more keys includes only the modifier key, performing a respective context dependent operation selected from the plurality of context dependent operations associated with the modifier key based on a current context; and in accordance with a determination that the set of one or more keys includes the modifier key and a respective key other than the modifier key, performing a respective shortcut operation selected from the plurality of shortcut operations associated with the modifier key based on the respective key.

In accordance with some embodiments, a computer-implemented method includes, at a device with a display and in communication with a physical keyboard: displaying a user interface that includes a content region for editing content, where the content region includes electronic content; while a first portion of the electronic content is selected, detecting a first activation of a key on the keyboard; in response to detecting the first activation of the key, copying the first portion of the electronic content; after copying the first portion of the electronic content, detecting a second activation of the key; and in response to detecting the second activation of the key: in accordance with a determination that a second portion of the electronic content is selected at the time of detection of the second activation, copying the second portion of the electronic content; and in accordance with a determination that no content is selected at the time of detection of the second activation, pasting the first content in the content region.

In accordance with some embodiments, an electronic device includes a display, one or more processors, memory; and one or more programs, where the one or more programs are stored in the memory and configured to be executed by the one or more processors, the one or more programs including instructions for performing any of the methods described above.

In accordance with some embodiments, a non-transitory computer-readable storage medium stores one or more programs, the one or more programs include instructions, which when executed by one or more processors of an electronic device with a display, cause the device to perform any of the methods described above.

In accordance with some embodiments, an electronic device includes a display and means for performing any of the methods described above.

In accordance with some embodiments, an electronic device includes a display unit configured to display a graphic user interface and a processing unit coupled to the display unit. The processing unit is configured to: detect a plurality of discrete inputs that includes a first input followed by a second input; and in response to detecting the plurality of discrete inputs, cause a sequence of operations that includes a first operation that corresponds to the first input followed by a second operation that corresponds to the second input, wherein causing the sequence of operations includes: in accordance with a determination that the plurality of discrete inputs meets an output-acceleration criteria, the first operation is performed with a first magnitude and the second operation is performed with a second magnitude that is greater than the first magnitude, and in accordance with a determination that the plurality of discrete inputs does not meet the output-acceleration criteria, the first operation and the second operation are performed with the same magnitude.

In accordance with some embodiments, an electronic device includes a display unit configured to display a graphic user interface and a processing unit coupled to the display unit. The processing unit is configured to: while a user interface is displayed on the display unit, detect a stationary input; in response to detecting the stationary input, enable translation of one or more elements of the user interface in accordance with the stationary input; after enabling translation of the one or more elements of the user interface in accordance with the stationary input, detect an end of the stationary input; and after detecting the end of the stationary input: in accordance with a determination that the stationary input meets translation-continuation criteria, continue to enable translation of the one or more elements of the user interface.

In accordance with some embodiments, an electronic device includes a display unit configured to display a graphic user interface and a processing unit coupled to the display unit and in communication with a physical keyboard. The processing unit is configured to: detect, while the display unit is displaying an active application, an activation of a key on the keyboard; in response to detecting the activation of the key: determine whether the device is operating in a first context or a second context; in accordance with a determination that the device is operating in the first context: enable display of representations of one or more content-sharing application on the display unit, while the representations of the one or more content-sharing applications are displayed, detect a first user input selecting a first content-sharing application of the one or more content-sharing applications, and in response to detecting the first user input selecting the first content-sharing application, provide data from the application to the first content-sharing application; and in accordance with a determination that the device is operating in the second context: enable display of representations of one or more content-viewing applications on the display unit, while the representations of the one or more content-viewing applications are displayed, detect a second user input selecting a first content-viewing application of the one or more content-viewing applications; and in response to detecting the second user input selecting the first content-viewing application, enable display of representations of one or more content items on the display unit, wherein the one or more content items are associated with the first content-viewing application.

In accordance with some embodiments, an electronic device includes a display unit configured to display a graphic user interface and a processing unit coupled to the display unit and in communication with a physical keyboard. The processing unit is configured to: detect an activation of a key on the keyboard; and in response to detecting the activation of the key: determine whether the device is operating in a first context or a second context, wherein electronic content is displayed on the display unit in the second context; in accordance with a determination that the device is operating in the first context, adjust a volume level associated with the context; and in accordance with a determination that the device is operating in the second context, adjust a zoom factor of the electronic content displayed in the second context.

In accordance with some embodiments, an electronic device includes a display unit configured to display a graphic user interface and a processing unit coupled to the display unit and in communication with a physical keyboard. The processing unit is configured to: detect an activation of a key on the physical keyboard; determine whether the activation of the key represents a first activation input or a second activation input; in accordance with a determination that the activation of the key represents the first activation input: enable receipt of a text input; and in accordance with a determination the activation of the key represents the second activation input: enable receipt of a voice input.

In accordance with some embodiments, an electronic device includes a display unit configured to display a graphic user interface and a processing unit coupled to the display unit and in communication with a physical keyboard. The processing unit is configured to: detect a downstroke input for each key in a set of one or more keys on the keyboard, the set of one or more keys including a modifier key that is associated with a plurality of context dependent operations and a plurality of shortcut operations associated with keys on the keyboard; and after detecting the downstroke input for each key in the set of one or more keys, detect an upstroke input for a respective key in the set of one or more keys; and in response to detecting the upstroke input for the respective key: in accordance with a determination that the set of one or more keys includes only the modifier key, cause a respective context dependent operation selected from the plurality of context dependent operations associated with the modifier key based on a current context; and in accordance with a determination that the set of one or more keys includes the modifier key and a respective key other than the modifier key, cause a respective shortcut operation selected from the plurality of shortcut operations associated with the modifier key based on the respective key.

In accordance with some embodiments, an electronic device includes a display unit configured to display a graphic user interface and a processing unit coupled to the display unit in communication with a physical keyboard. The processing unit is configured to: enable display of a user interface that includes a content region for editing content, wherein the content region includes electronic content; while a first portion of the electronic content is selected, detect a first activation of a key on the keyboard; in response to detecting the first activation of the key, copy the first portion of the electronic content; after copying the first portion of the electronic content, detect a second activation of the key; and in response to detecting the second activation of the key: in accordance with a determination that a second portion of the electronic content is selected at the time of detection of the second activation, copy the second portion of the electronic content; and in accordance with a determination that no content is selected at the time of detection of the second activation, paste the first content in the content region.

Thus, devices are provided with faster, more efficient methods and interfaces for viewing, creating, editing, and sharing content using an electronic device, thereby increasing the effectiveness, efficiency, and user satisfaction with such devices. Such methods and interfaces may complement or replace other methods for viewing content or performing context-dependent operations and shortcuts.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5 illustrates an exemplary multifunction device in communication with an exemplary physical keyboard in accordance with some embodiments.

FIGS. 6A-6C illustrate exemplary user interfaces in accordance with some embodiments.

FIG. 7 is a flow diagram illustrating an exemplary process for displaying user interfaces in accordance with some embodiments.

FIG. 8 illustrates a functional block diagram in accordance with some embodiments.

FIGS. 9A-9E illustrate exemplary user interfaces in accordance with some embodiments.

FIG. 10 is a flow diagram illustrating an exemplary process for displaying user interfaces in accordance with some embodiments.

FIG. 11 illustrates a functional block diagram in accordance with some embodiments.

FIGS. 12A-12D illustrate exemplary user interfaces in accordance with some embodiments.

FIG. 13 is a flow diagram illustrating an exemplary process for displaying user interfaces in accordance with some embodiments.

FIG. 14 illustrates a functional block diagram in accordance with some embodiments.

FIGS. 15A-15E illustrate exemplary user interfaces in accordance with some embodiments.

FIG. 16 is a flow diagram illustrating an exemplary process for displaying user interfaces in accordance with some embodiments.

FIG. 17 illustrates a functional block diagram in accordance with some embodiments.

FIGS. 18A-18I illustrate exemplary user interfaces in accordance with some embodiments.

FIG. 19 is a flow diagram illustrating an exemplary process for displaying user interfaces in accordance with some embodiments.

FIG. 20 illustrates a functional block diagram in accordance with some embodiments.

FIG. 21 illustrates an exemplary user interface in accordance with some embodiments.

FIG. 22 is a flow diagram illustrating an exemplary process for displaying user interfaces in accordance with some embodiments.

FIG. 23 illustrates a functional block diagram in accordance with some embodiments.

FIGS. 24A-24D illustrate exemplary user interfaces in accordance with some embodiments.

FIG. 25 is a flow diagram illustrating an exemplary process for displaying user interfaces in accordance with some embodiments.

FIG. 26 illustrates a functional block diagram in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for using a keyboard to view, create, edit, and share content. In some embodiments, a key on a keyboard (virtual or physical) performs different operations depending on the context in which the device is operating. In some embodiments, rapidly tapping or holding down a key increases the rate at which an operation (e.g., scrolling) is performed. Such techniques can reduce the cognitive burden on a user and may allow a user to perform certain tasks (e.g., viewing content or composing a text document) more efficiently, thereby enhancing productivity. Further, such techniques can reduce processor and battery power otherwise wasted on redundant user inputs and inefficient operation.

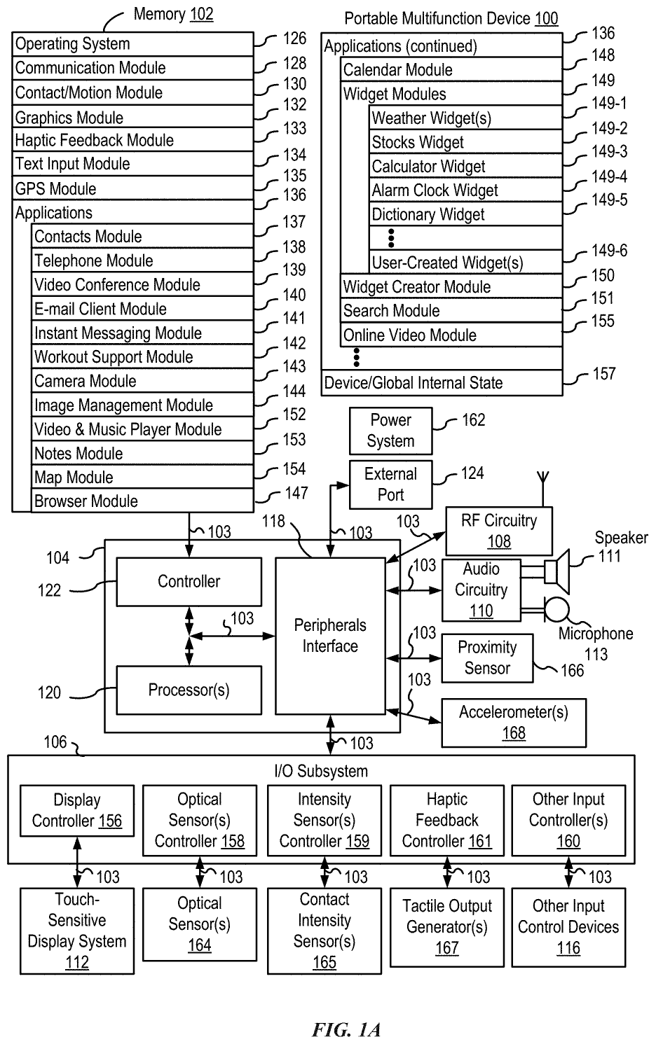

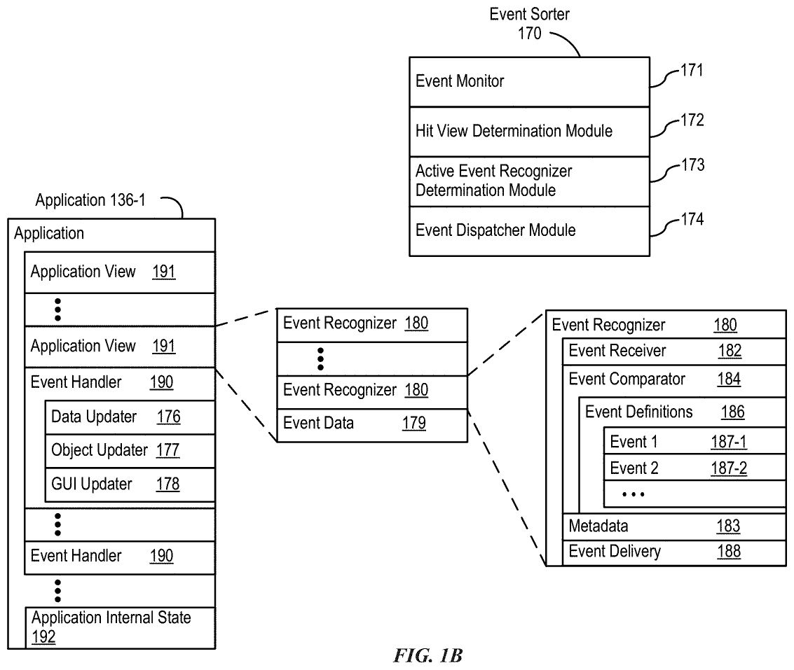

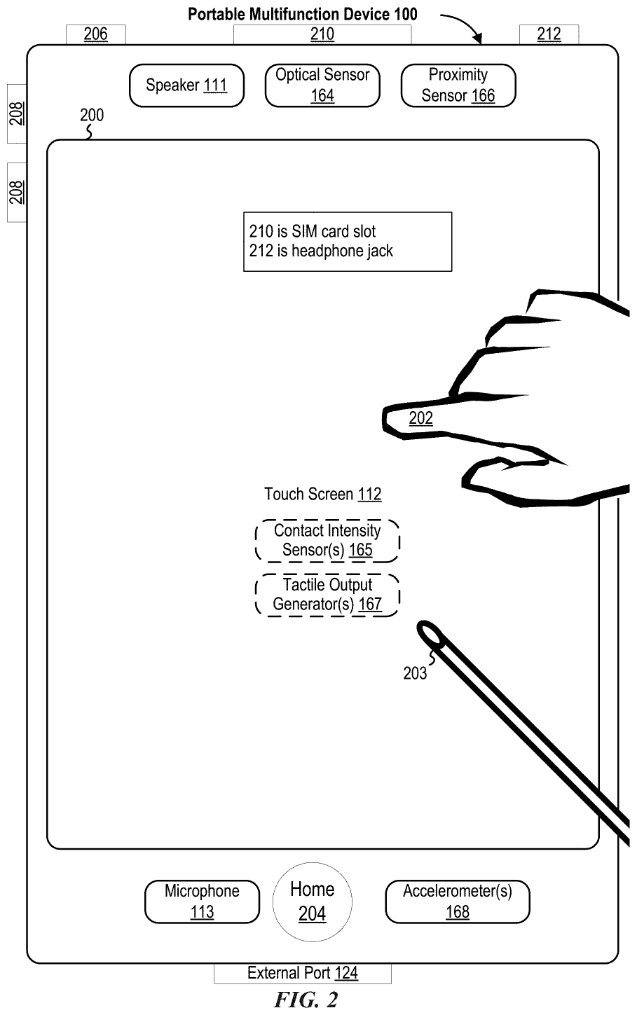

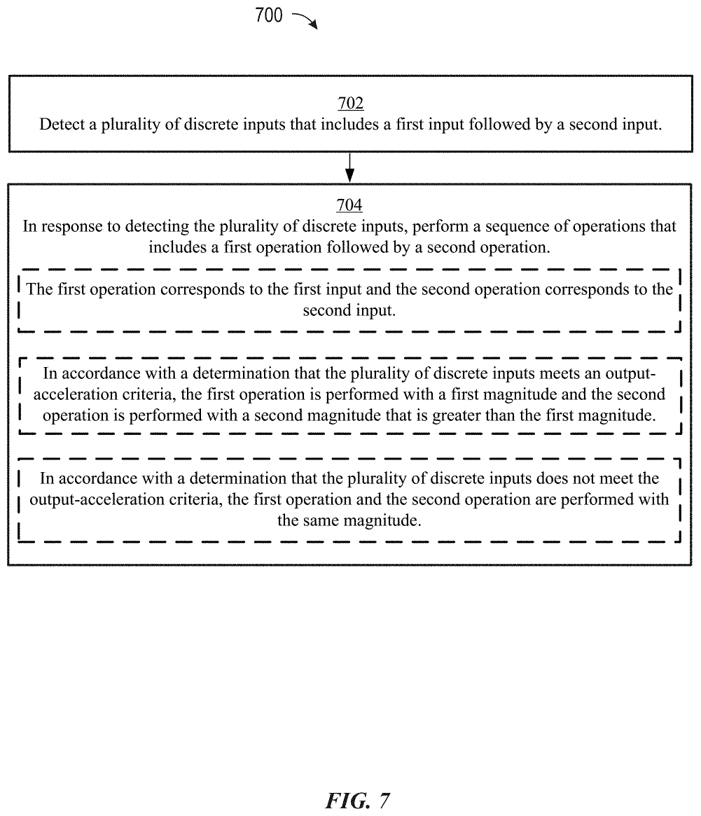

Below, FIGS. 1A-1B, 2, 3, and 4A-4B provide a description of exemplary devices for performing techniques including viewing, creating, editing, and sharing content and performing context-dependent operations. FIGS. 6A-6G, 2A-12D, 15A-15E, 18A-18I, 21, and 24A-24D illustrate exemplary user interfaces for using a keyboard to view, create, edit and share content and perform context-dependent operations. FIGS. 7, 10, 13, 16, 19, 22, and 25 are flow diagrams illustrating methods in accordance with some embodiments. The user interfaces in FIGS. 6A-6G, 2A-12D, 15A-15E, 18A-18I, 21, and 24A-24D are used to illustrate the processes described below, including the processes in FIGS. 7, 10, 13, 16, 19, 22, and 25.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device may support a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 may include one or more computer-readable storage mediums. The computer-readable storage mediums may be tangible and non-transitory. Memory 102 may include high-speed random access memory and may also include non-volatile memory, such as one or more magnetic disk storage devices, flash memory devices, or other non-volatile solid-state memory devices. Memory controller 122 may control access to memory 102 by other components of device 100.

Memory 102 of device 100 can be a non-transitory computer-readable storage medium, for storing computer-executable instructions, which, when executed by one or more computer processors 120, for example, can cause the computer processors to perform the techniques described below, including processes 700, 1000, 1300, 1600, 1900, 2200, and 2500 (FIGS. 7, 10, 13, 16, 19, 22, and 25). The computer-executable instructions can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. For purposes of this document, a “non-transitory computer-readable storage medium” can be any medium that can tangibly contain or store computer-executable instructions for use by or in connection with the instruction execution system, apparatus, or device. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 may be implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button may disengage a lock of touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) may turn power to device 100 on or off. The user may be able to customize a functionality of one or more of the buttons. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 may use LCD (liquid crystal display) technology, LPD (light emitting polymer display) technology, or LED (light emitting diode) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 may be analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 may have a video resolution in excess of 100 dpi. In some embodiments, the touch screen has a video resolution of approximately 160 dpi. The user may make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from touch screen 112 or an extension of the touch-sensitive surface formed by the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIG. 1A shows an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device so that the touch screen display may be used as a viewfinder for still and/or video image acquisition. In some embodiments, an optical sensor is located on the front of the device so that the user's image may be obtained for video conferencing while the user views the other video conference participants on the touch screen display. In some embodiments, the position of optical sensor 164 can be changed by the user (e.g., by rotating the lens and the sensor in the device housing) so that a single optical sensor 164 may be used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 may also include one or more proximity sensors 166. FIG. 1A shows proximity sensor 166 coupled to peripherals interface 118. Alternately, proximity sensor 166 may be coupled to input controller 160 in I/O subsystem 106. Proximity sensor 166 may perform as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 may also include one or more accelerometers 168. FIG. 1A shows accelerometer 168 coupled to peripherals interface 118. Alternately, accelerometer 168 may be coupled to an input controller 160 in I/O subsystem 106. Accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

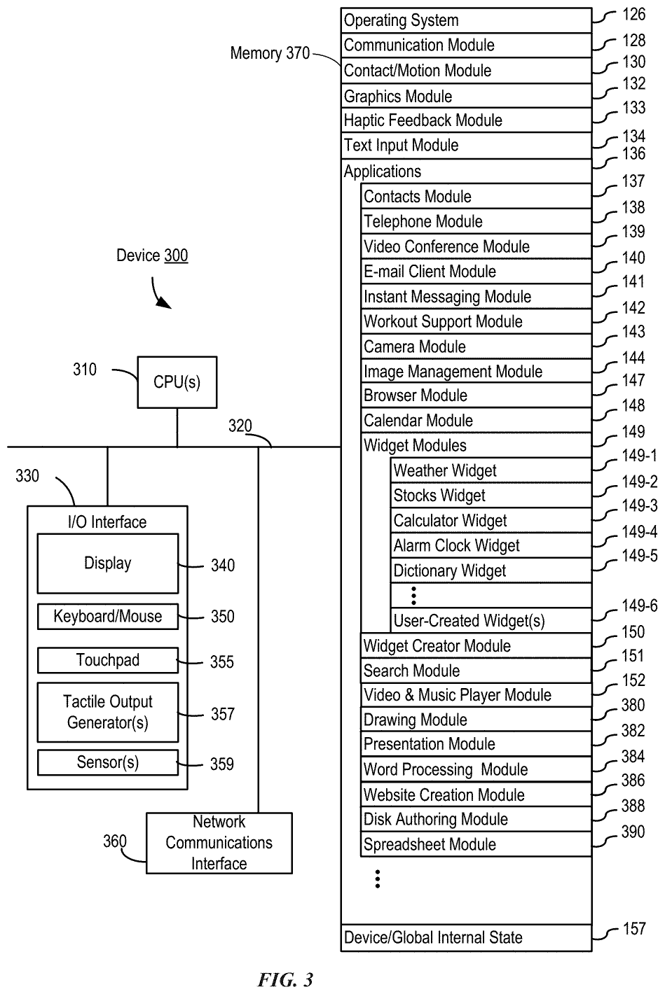

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which may be a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 may include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which may include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 may be used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 may be used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication may use any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages may include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 may be used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 may be used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules may be combined or otherwise rearranged in various embodiments. For example, video player module may be combined with music player module into a single module (e.g., video and music player module 152, FIG. 1A). In some embodiments, memory 102 may store a subset of the modules and data structures identified above. Furthermore, memory 102 may store additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 may be reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 may utilize or call data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 may also include one or more physical buttons, such as “home” or menu button 204. As described previously, menu button 204 may be used to navigate to any application 136 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 may be stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules may be combined or otherwise rearranged in various embodiments. In some embodiments, memory 370 may store a subset of the modules and data structures identified above. Furthermore, memory 370 may store additional modules and data structures not described above.

Attention is now directed towards embodiments of user interfaces that may be implemented on, for example, portable multifunction device 100.

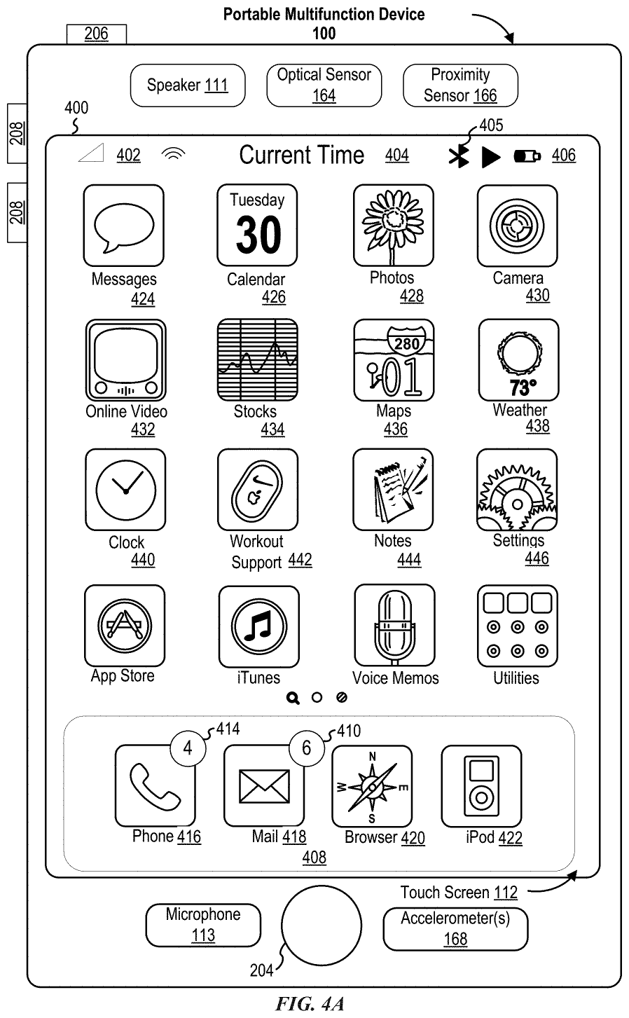

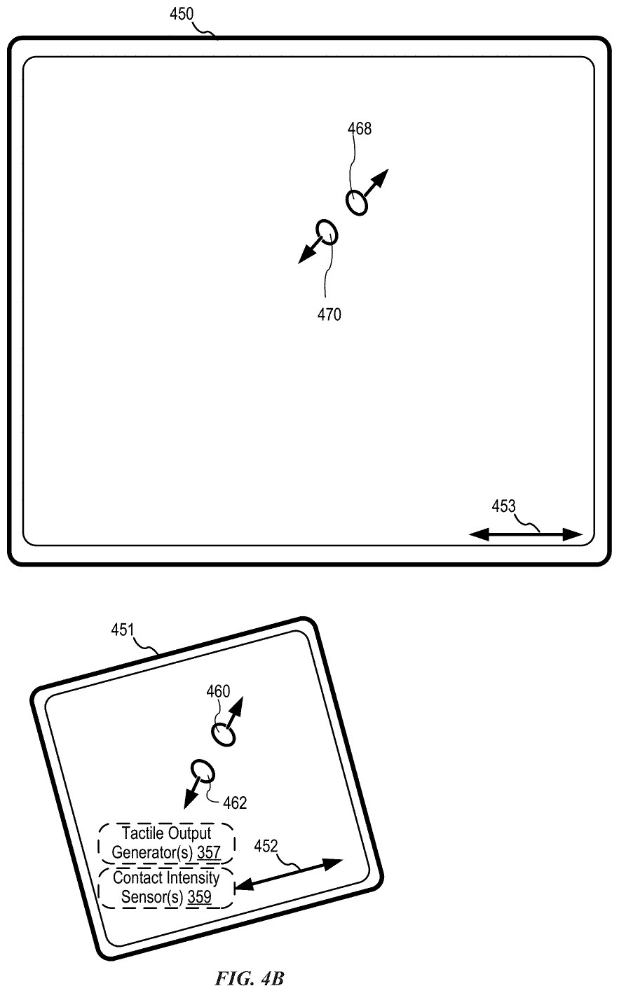

FIG. 4A illustrates an exemplary user interface for a menu of applications on portable multifunction device 100 in accordance with some embodiments. Similar user interfaces may be implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 may optionally be labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 357) for detecting intensity of contacts on touch-sensitive surface 451 and/or one or more tactile output generators 359 for generating tactile outputs for a user of device 300.

Techniques for detecting and processing contact intensity may be found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety

Although some of the examples which follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used here, the term “affordance” refers to a user-interactive graphical user interface object that may be displayed on the display screen of devices 100, 300, and/or 500 (FIGS. 1, 3, and 5). For example, an image (e.g., icon), a button, and text (e.g., hyperlink) may each constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds may include a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface may receive a continuous swipe contact transitioning from a start location and reaching an end location, at which point the intensity of the contact increases. In this example, the characteristic intensity of the contact at the end location may be based on only a portion of the continuous swipe contact, and not the entire swipe contact (e.g., only the portion of the swipe contact at the end location). In some embodiments, a smoothing algorithm may be applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface may be characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the term “open application” or “executing application” refers to a software application with retained state information (e.g., as part of device/global internal state 157 and/or application internal state 192). An open or executing application may be any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed to embodiments of user interfaces and associated processes that may be implemented on an electronic device, such as portable multifunction device 100 or device 300.

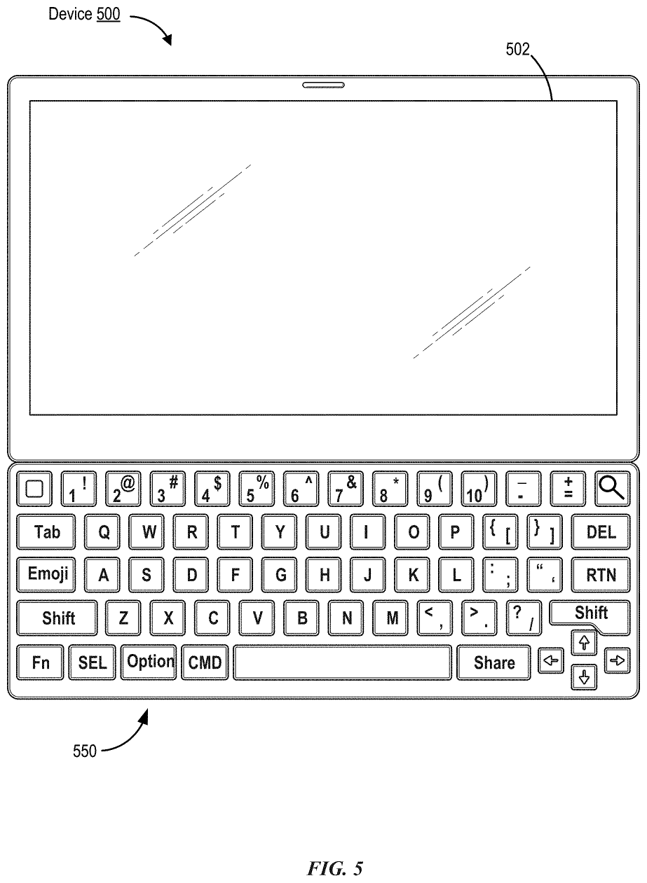

FIG. 5 illustrates an exemplary device 500 in communication with a physical keyboard 550. According to some embodiments, device 500 is an electronic device, such as portable multifunction device 100 or 300. Device 500 includes display 502, which is, optionally, touch-sensitive and configured to receive contacts. In some embodiments, device 500 is connected to keyboard 550 via a wired interface or a wireless interface such as, for example, Bluetooth. In FIG. 5, keyboard 550 is physically connected to device 500. In some embodiments, keyboard 550 is removably connectable to device 500 or remote from device 500.

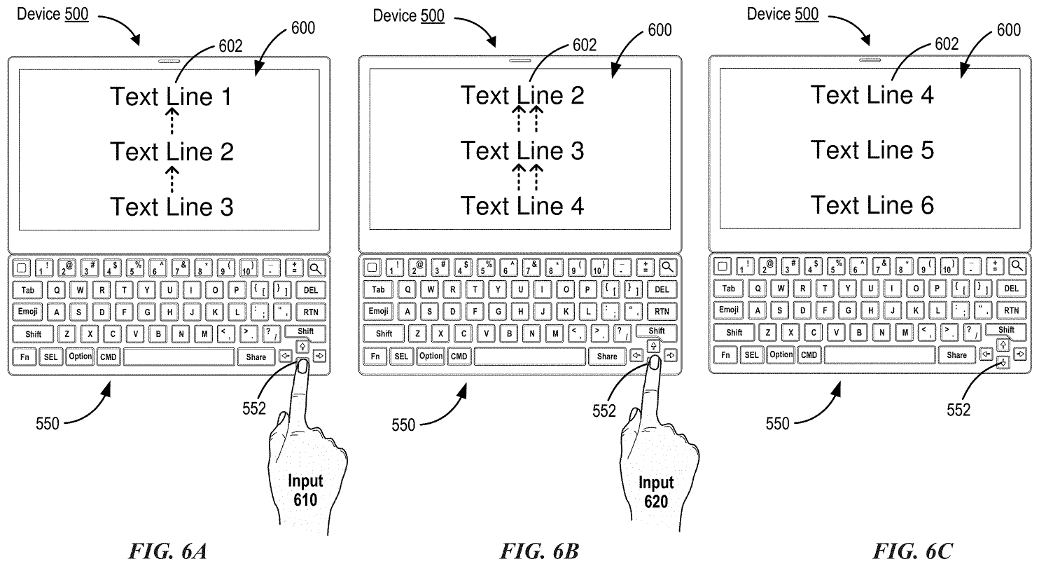

FIGS. 6A-6C illustrate exemplary user interfaces for performing operations on an electronic device (e.g., 100, 300, or 500), in accordance with some embodiments. The user interfaces in these figures are used to illustrate the processes described below, including the processes in FIG. 7.

FIG. 6A illustrates user interface 600 with a portion of electronic content 602 displayed on device 500. In the illustrated example, electronic content 602 is an electronic document with lines of text, where Text Lines 1-3 are initially displayed. Electronic documents include, for example, a portable document file, word processing document, email, electronic spreadsheet, electronic presentation document, or the like. Other examples of electronic content include a webpage, an image, a cursor, and a graphical user interface screen of an application.

In FIG. 6A, a user provides a discrete input 610 on keyboard 550. In the illustrated example, discrete input 610 is an activation of a down arrow key 552 on keyboard 550. An activation of a key can include, for example, a press (e.g., a downstroke input) and/or liftoff (e.g., an upstroke input).

In response to detecting input 610, device 500 performs an operation corresponding to the activation of key 552. In FIG. 6A, electronic content 602 is scrolled upward at a first rate (indicated by the single dashed arrows) to display a second portion of electronic content 602 including Text Lines 2-4, as shown in FIG. 6B. Exemplary factors that determine the operation performed on the electronic content include the key that is activated, the type of electronic content, and/or the context in which the electronic content is displayed (e.g., an editing mode or a viewing mode). Other exemplary types of operations include a cursor movement operation and a character deletion operation. Also, it should be recognized that the dashed arrows are for illustration purposes only and are not part of user interface 600.

In FIG. 6B, the user activates key 552 another time with a second discrete input 620. In response to detecting second input 620, device 500 performs a second operation corresponding to the second activation of key 552. Device 500 causes the electronic content 602 to be further scrolled upward at a second rate (indicated by the double dashed arrows) to display a third portion of electronic content including Text Lines 5-6, as shown in FIG. 6C. In some embodiments, additional discrete inputs are received, each resulting in a corresponding operation.

In the illustrated example, the magnitude of the operation corresponding to the second input 620 is greater than the magnitude of the operation corresponding to the first input 610. In some embodiments, the magnitude of the second operation decreases over a duration of time to a magnitude of zero. For example, the scrolling corresponding to second input 620 optionally decreases from the second rate to zero over a duration of one second.

The features described with respect to FIGS. 6A-6C may allow a user to control the amount and rate of scrolling based on how many times and how quickly input is provided. In one exemplary embodiment, a user can tap down arrow key 552 once to move down one line in electronic content 602. Tapping down arrow key 552 again after a predetermined amount of time moves down another line. In this way, a user can move electronic content 602 one line at a time by tapping down arrow key 552 every so often.

Alternatively, a user can provide multiple inputs over a short amount of time to scroll electronic content with inertia. For example, by tapping down arrow key 552 multiple times in rapid succession, electronic content may be scrolled at a certain rate and continue to scroll, slowing down gradually after tapping has stopped. The rate of scrolling and how long scrolling continues after input has ceased can depend on the number of inputs and how quickly they are provided. In some embodiments, content is scrolled faster and longer the more rapidly down arrow key 552 is tapped. This may provide the advantage of increasing the speed at which content is navigated in response to an indication (e.g., rapid tapping of down arrow key 552) that the user wishes to move a large amount within the content.

The described behavior in response to keyboard inputs may also have the advantage of being similar in some respects to the manner in which device 500 responds to touch inputs. Such techniques can allow a user to use a keyboard to perform an operation, such as scrolling, in a way that can also be achieved by touch inputs. For example, in some embodiments, device 500 includes a touch sensitive display, and in response to a touch input on the display of device 500 (e.g., a quick upward vertical swipe or flick), electronic content 602 is scrolled with inertia in the same way as in response to multiple, rapid taps on down arrow key 552.

In some embodiments, device 500 determines whether at least a portion of any discrete inputs on keyboard 550 (e.g., first input 610 or second input 620) meets an output-acceleration criteria. The output-acceleration criteria include, for example, a criterion that is met when a duration of time between first input 610 and second input 620 is less than a predetermined threshold, or when the number of detected inputs exceeds a predetermined threshold within a predetermined duration of time. In some embodiments, the predetermined duration of time is at least one second.

In some embodiments, in accordance with a determination that the output-acceleration criteria is met, the operation corresponding to the second input 620 is performed with a greater magnitude than the operation corresponding to the first input, such as in the example described above with respect to FIGS. 6A-6C. In the illustrated example, the magnitude is the rate at which scrolling is performed. In some embodiments, the magnitude is the amount of scrolling (e.g., number of lines) irrespective of time. In some embodiments, the magnitude is another characteristic associated with the performed operation that can increase or decrease.

Alternatively, in accordance with a determination that the output-acceleration criteria are not met, the first operation and the second operation are performed with the same magnitude. For example, instead of performing the scrolling operations as described above, if first input 610 and second input 620 do not meet the output-acceleration criteria, the electronic content 602 is scrolled at the first rate indicated by the single dashed arrows in response to each input. In this way, a user can control the rate at which an operation such as scrolling is performed by how many times and/or how rapidly the key associated with the operation is activated.

In some embodiments, device 500 includes a touch-sensitive display, and can perform the operations described herein in response to touch inputs on the display of device 500. For example, in some embodiments, scrolling with inertia is performed in response to a touch input, and the rate of scrolling and amount of inertia (e.g., how long scrolling continues after the touch input) is based on the characteristics of the touch input (e.g., the magnitude and velocity of a swipe gesture).

Also, although the examples above refer to inputs on a physical keyboard, in some embodiments, the discrete input can be a contact detected at a location of a virtual key on a virtual keyboard presented on display 502.

FIG. 7 is a flow diagram illustrating a method for controlling the magnitude of operations using an electronic device in accordance with some embodiments. Method 700 is performed at a device (e.g., 100, 300, or 500) with a display. Some operations in method 700 may be combined, the order of some operations may be changed, and some operations may be omitted.

As described below, method 700 provides an intuitive way for adjusting the magnitude of an operation. The method reduces the cognitive burden on a user for controlling the magnitude of operations, thereby creating a more efficient human-machine interface. For battery-operated computing devices, enabling a user to control the magnitude of operations faster and more efficiently conserves power and increases the time between battery charges.

At block 702, a plurality of discrete inputs (e.g., input 610 and input 620) is detected. The plurality of inputs includes a first input (e.g., input 610) followed by a second input (e.g., input 620).

At block 704, in response to detecting the plurality of discrete inputs, a sequence of operations is performed. The sequence of operations includes a first operation (e.g., FIG. 6A, scrolling at a first rate) that corresponds to the first input (e.g., input 610) followed by a second operation (e.g., FIG. 6B, scrolling at a second rate) that corresponds to the second input (e.g., input 620). In some embodiments, the first operation and the second operation are scrolling operations of electronic content (e.g., an electronic document) at least partially displayed on the display. In some embodiments, the first operation and the second operation are cursor movement operations or character deletion operations. In some embodiments, the plurality of discrete inputs includes a plurality of activations of a key of a physical keyboard that is in communication with the device. In some embodiments, the display is a touch-sensitive display and the plurality of discrete inputs includes a plurality of contacts at a location of a virtual key on a virtual keyboard.

In accordance with a determination that the plurality of discrete inputs meets an output-acceleration criteria, the first operation is performed with a first magnitude (e.g., scrolling rate indicated by dashed arrows in FIG. 6A) and the second operation is performed with a second magnitude that is greater than the first magnitude (e.g., scrolling rate indicated by double dashed arrows in FIG. 6B). In accordance with a determination that the plurality of discrete inputs does not meet the output-acceleration criteria, the first operation and the second operation are performed with the same magnitude. In some embodiments, the output-acceleration criteria include a criterion that is met when a duration of time between the first input and the second input is less than a predetermined threshold. In some embodiments, the output-acceleration criteria include a criterion that is met when the number of discrete inputs within a predetermined duration of time (e.g., one second) exceeds a predetermined threshold number of inputs. In some embodiments, the magnitude of the second operation decreases over a duration of time (e.g., one second) to a magnitude of zero.

Note that details of the processes described above with respect to method 700 (e.g., FIG. 7) are also applicable in an analogous manner to the methods described below. For example, the inputs, outputs, interfaces, applications, keyboards, and operations described with respect to methods 1000, 1300, 1600, 1900, 2200, or 2500 may include one or more of the inputs, outputs, interface, application, keyboard, and operations described above with reference to method 700.

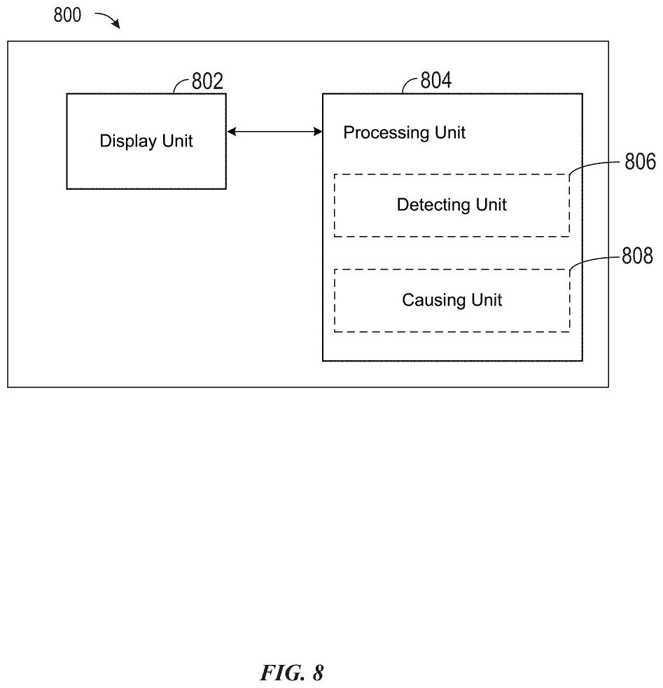

In accordance with some embodiments, FIG. 8 shows an exemplary functional block diagram of an electronic device 800 configured in accordance with the principles of the various described embodiments. In accordance with some embodiments, the functional blocks of electronic device 800 are configured to perform the techniques described above. The functional blocks of the device 800 are, optionally, implemented by hardware, software, or a combination of hardware and software to carry out the principles of the various described examples. It is understood by persons of skill in the art that the functional blocks described in FIG. 8 are, optionally, combined or separated into sub-blocks to implement the principles of the various described examples. Therefore, the description herein optionally supports any possible combination or separation or further definition of the functional blocks described herein.

As shown in FIG. 8, an electronic device 800 includes a display unit 802 configured to display a graphic user interface and a processing unit 804 coupled to the display unit 802. In some embodiments, the processing unit 804 includes a detecting unit 806 and a causing unit 808.

The processing unit 804 is configured to: detect (e.g., with detecting unit 806) a plurality of discrete inputs that includes a first input followed by a second input; and in response to detecting the plurality of discrete inputs, cause (e.g., with causing unit 808) a sequence of operations that includes a first operation that corresponds to the first input followed by a second operation that corresponds to the second input. Causing the sequence of operations includes: in accordance with a determination that the plurality of discrete inputs meets an output-acceleration criteria, the first operation is performed with a first magnitude and the second operation is performed with a second magnitude that is greater than the first magnitude, and in accordance with a determination that the plurality of discrete inputs does not meet the output-acceleration criteria, the first operation and the second operation are performed with the same magnitude.

In some embodiments, the first operation and the second operation are scrolling operations of electronic content at least partially displayed on the display unit 802. In some embodiments, the electronic content includes an electronic document. In some embodiments, the first operation and the second operation are cursor movement operations. In some embodiments, the first operation and the second operation are character deletion operations.

In some embodiments, the magnitude of the second operation decreases over a duration of time to a magnitude of zero. In some embodiments, the duration of time is one second.

In some embodiments, the output-acceleration criteria include a criterion that is met when a duration of time between the first input and the second input is less than a predetermined threshold. In some embodiments, the output-acceleration criteria include a criterion that is met when the number of discrete inputs within a predetermined duration of time exceeds a predetermined threshold number of inputs. In some embodiments, the predetermined duration of time is at least one second.

In some embodiments, the plurality of discrete inputs includes a plurality of activations of a key of a physical keyboard that is in communication with the device 800. In some embodiments, the display unit 802 is touch-sensitive and the plurality of discrete inputs includes a plurality of contacts at a location of a virtual key on a virtual keyboard displayed on the display unit 802.

The operations described above with reference to FIG. 7 are, optionally, implemented by components depicted in FIGS. 1A-1B or FIG. 8. For example, detecting operation 702 and performing operation 704 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

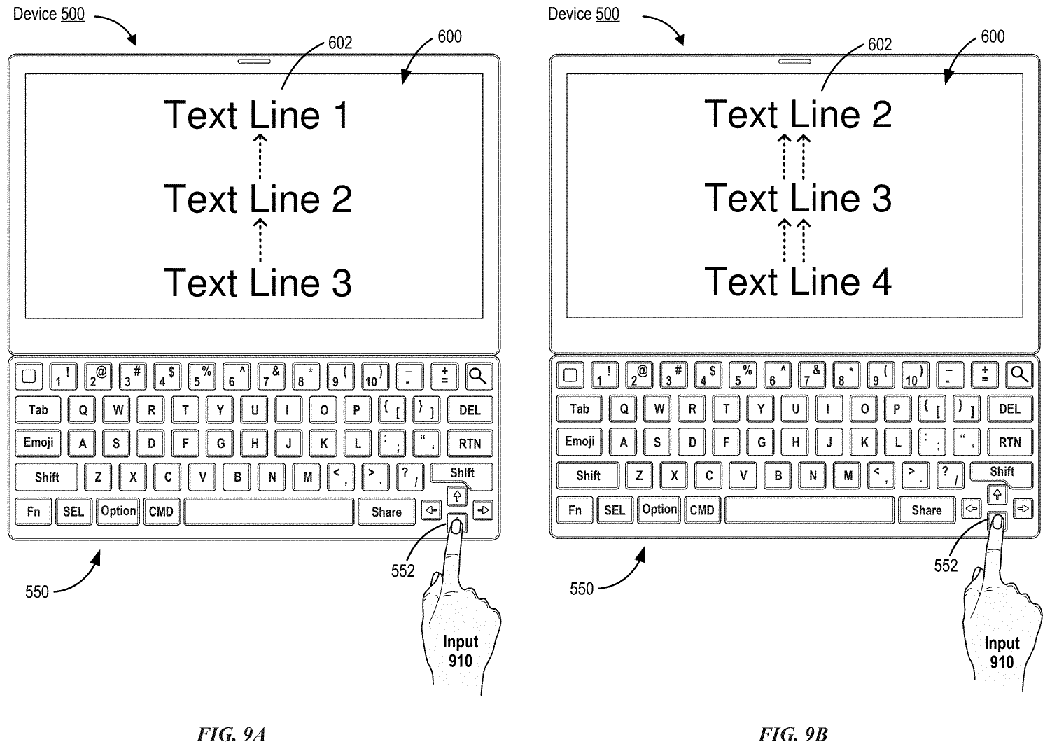

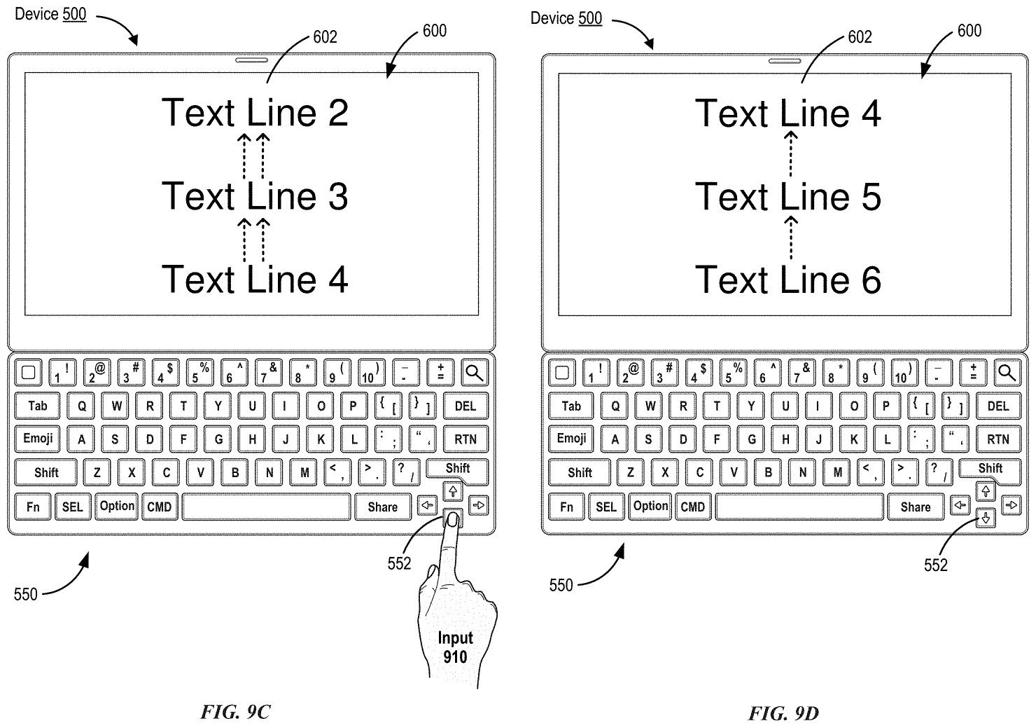

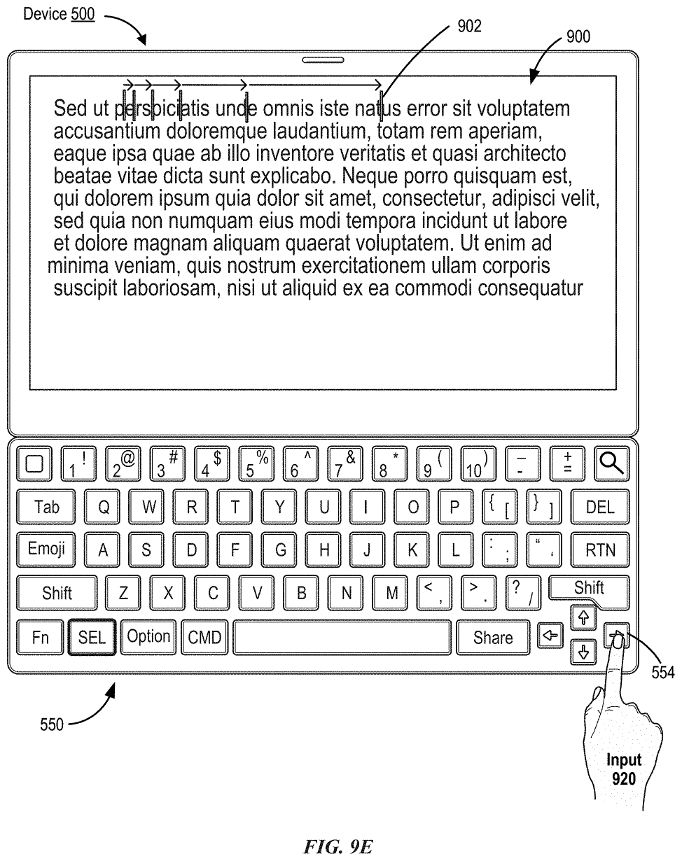

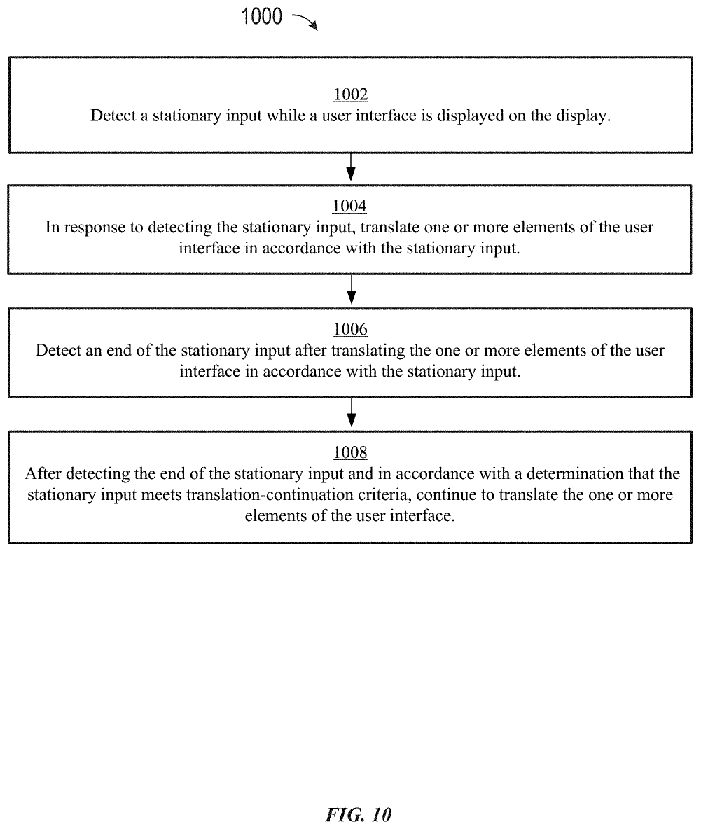

Attention is now directed to FIGS. 9A-9E, which illustrate additional embodiments of user interfaces and associated processes that may be implemented on an electronic device (e.g., 100, 300, or 500). The user interfaces in these figures are used to illustrate the processes described below, including the processes in FIG. 10.

FIG. 9A again illustrates device 500 displaying user interface 600 including a portion of electronic content 602. In FIG. 9A, a user provides a stationary input 910 to activate key 552. Exemplary stationary inputs include a press and hold gesture. Optionally, display 502 is touch-sensitive and the stationary input includes a detected contact at a location of a virtual key on a virtual keyboard displayed on device 500.

In response to detecting the stationary input 910, one or more elements of the user interface 600 are translated in accordance with stationary input 910. In the illustrated example, the one or more elements of the user interface 600 include electronic content 602, which is scrolled in response to detecting stationary input 910. In some embodiments, the one or more elements of the user interface include a cursor that is translated (e.g., horizontally) on display 502, as illustrated for example in FIG. 9E, discussed in greater detail below.

As indicated in FIG. 9A, the one or more elements (e.g., electronic content 602) is initially translated vertically upward at a rate indicated by the single dashed arrows. Optionally, the rate of translation is determined based on the number of sequential inputs detected prior to detecting the stationary input 910. In some embodiments, a single tap and hold (e.g., a press and hold) of down key 552 causes electronic content 602 to be translated at a first rate, a double tap and hold (e.g., a press and release followed by a press and hold) causes electronic content 602 to be translated at a second rate that is greater than the first rate (e.g., two times the first rate), and a triple tap and hold (e.g., two consecutive press and release inputs followed by a press and hold) causes electronic content 602 to be translated at a third rate that is greater than the second rate (e.g., five times the first rate).

In some embodiments, a determination is made whether the stationary input 910 meets translation-acceleration criteria. Optionally, the translation-acceleration criteria are based at least in part on how long stationary input 910 has been detected, such that the translation-acceleration criteria is met when the duration of stationary input 910 exceeds a predetermined threshold (e.g., one second).

In accordance with a determination that the stationary input 910 does not meet the translation-acceleration criteria, translation of the one or more elements of the user interface 600 (e.g., electronic content 602) continues at the same rate over time. Alternatively, in accordance with a determination that the stationary input meets the translation-acceleration criteria, the translation of the one or more elements of the user interface 600 (e.g., electronic content 602) is accelerated over time. As illustrated in FIG. 9B, for example, stationary input 910 is maintained at key 552 (e.g., key 552 is pressed and held) for a threshold amount of time (e.g., greater than one second) and, in response, the rate of translation is increased to twice the initial rate, as indicated by the double dashed arrows.

Optionally, a maximum acceleration factor is determined based on the number of associated sequential inputs received prior to receiving stationary input 910. In some embodiments, if the stationary input 910 is not preceded by another associated input, the translation accelerates to a maximum rate of two times the first rate. Alternatively, if one or more activations of key 552 are detected prior to detecting stationary input 910, the translation accelerates to a maximum rate of five times the first rate. According to this technique, a user may control the maximum rate at which translation is performed. In some embodiments, translation of the one or more element of the user interface 600 is accelerated smoothly.

In some embodiments, device 500 determines whether stationary input 910 meets translation-continuation criteria. Translation-continuation criteria may be based on, for example, whether the stationary input 910 exceeds a predetermined threshold (e.g., whether the duration of the stationary input 910 exceeds a threshold amount of time). In accordance with a determination that the stationary input 910 does not meet the translation-continuation criteria, translation of electronic content 602 is ceased after an end of the stationary input 910 is detected. Alternatively, in accordance with a determination that the translation-continuation criteria are met, device 500 continues to translate electronic content 602 after an end of the stationary input 910 is detected. In FIG. 9C, for example, electronic content 602 is translated at a rate indicated by the double dashed arrows while receiving stationary input 910. In FIG. 9D, stationary input 910 is released and translation of electronic content 602 continues. Optionally, after the end of the stationary input 910 is detected, the rate of the continued translation is reduced over time. This is illustrated by the single dashed arrows in FIG. 9D. In some embodiments, the rate of translation is reduced in accordance with a simulated physical characteristic of the electronic content 602, such as simulated inertia and/or friction.

As mentioned above, FIG. 9E illustrates another embodiment in which the one or more elements of a user interface is a cursor 902 in the graphical user interface 900 of a text editing application. In FIG. 9E, cursor 902 is translated in response to stationary input 920 on the right arrow key 554 in accordance with the techniques described above. As indicated by the increasing length of the arrows from left to right at the top of user interface 900, FIG. 9E illustrates an example in which cursor 902 is translated horizontally across a line of text at an increasing rate as the user maintains stationary input 920. The arrows are for illustration purposes only and are not part of user interface 900.

Similarly to the features described with reference to FIGS. 6A-6C, the features described with respect to FIGS. 9A-9E may provide another technique for a user to control the amount and rate of scrolling based on how many times and how quickly input is provided. For example, a user can scroll through electronic content 602 at a constant rate by pressing and holding down arrow key 552 for a short amount of time. A user can control the rate of scrolling by providing one or more tap inputs immediately prior to pressing and holding. The rate of scrolling can be proportional to the number of immediately preceding taps. A user can also control the rate of scrolling and cause the electronic content to scroll with inertia based on the how the key is held. For example, by holding down arrow key 552 longer than a predetermined amount of time, the electronic content will scroll faster and also continue to scroll after the press-and-hold is released. The longer the press is held, the faster the electronic content will be scrolled. This may provide the advantage of increasing the speed at which content is navigated in response to an indication that the user wishes to move a large amount within the content. The indication may be in the form of multiple taps immediately prior to a press-and-hold or an extended press-and-hold input.

The described behavior in response to keyboard inputs may also have the advantage of being similar in some respects to the manner in which device 500 responds to touch inputs. Such techniques can allow a user to use a keyboard to perform an operation, such as scrolling, in a way that can also be achieved by touch inputs. For example, in some embodiments, device 500 includes a touch sensitive display, and in response to a touch input on the display of device 500 (e.g., a quick upward vertical swipe or flick), electronic content 602 is scrolled. The rate of scrolling and amount of inertia may be determined by the characteristics of the touch input (e.g., the length and/or velocity of a swipe gesture). As described above, similar behavior may be achieved by multiple taps and/or an extended press-and-hold input.

FIG. 10 is a flow diagram illustrating a method for translating elements of a user interface using an electronic device in accordance with some embodiments. Method 1000 is performed at a device (e.g., 100, 300, or 500) with a display. Some operations in method 1000 may be combined, the order of some operations may be changed, and some operations may be omitted.

As described below, method 1000 provides an intuitive way for translating elements of a user interface. The method reduces the cognitive burden on a user for translating elements of a user interface, thereby creating a more efficient human-machine interface. For battery-operated computing devices, enabling a user to translate elements of a user interface faster and more efficiently conserves power and increases the time between battery charges.

At block 1002, a stationary input (e.g., input 910) is detected while a user interface (e.g., 600) is displayed on the display (e.g., 502). In some embodiments, the stationary input includes an activation of a key on a physical keyboard in communication with the device. In some embodiments, the display is a touch-sensitive display and the stationary input includes a detected contact at a location of a virtual key on a virtual keyboard.

At block 1004, in response to detecting the stationary input, one or more elements of the user interface (e.g., electronic content 602) are translated in accordance with the stationary input. Optionally, a rate of translation while detecting the stationary input is determined based on a number of sequential inputs that occurred prior to detecting the stationary input. In some embodiments, translating the one or more elements of the user interface includes moving a cursor (e.g., cursor 902) horizontally on the display or scrolling electronic content (e.g., an electronic document) at least partially displayed on the display.

Optionally, a determination is made whether the stationary input meets translation-acceleration criteria. In some embodiments, the translation-acceleration criteria include a criterion that is met when a duration of the stationary input exceeds a predetermined threshold. In accordance with a determination that the stationary input meets the translation-acceleration criteria, translation of the one or more elements of the user interface is accelerated over time; and in accordance with a determination that the stationary input does not meet the translation-acceleration criteria, translation of the one or more elements of the user interface is continued at the same rate over time. In some embodiments, translation of the one or more element of the user interface is accelerated smoothly from a first rate to a second rate.

At block 1006, an end of the stationary input is detected after translating the one or more elements of the user interface in accordance with the stationary input.

At block 1008, after detecting the end of the stationary input and in accordance with a determination that the stationary input meets translation-continuation criteria, translation of the one or more elements of the user interface is continued (e.g., FIG. 9D). In some embodiments, the translation-continuation criteria include a criterion that is met when a duration of the stationary input exceeds a predetermined threshold. Optionally, continuing to translate the one or more elements of the user interface includes reducing a speed of the translation of the one or more user interface objects over time. In some embodiments, after detecting the end of the stationary input and in accordance with a determination that the stationary input does not meet the translation-continuation criteria, translation of the one or more elements of the user interface is ceased.

Note that details of the processes described above with respect to method 1000 (e.g., FIG. 10) are also applicable in an analogous manner to the methods described below and above. For example, the inputs, outputs, interfaces, applications, keyboards, and operations described with respect to methods 700, 1300, 1600, 1900, 2200, or 2500 may include one or more of the inputs, outputs, interface, application, keyboard, and operations described above with reference to method 1000.

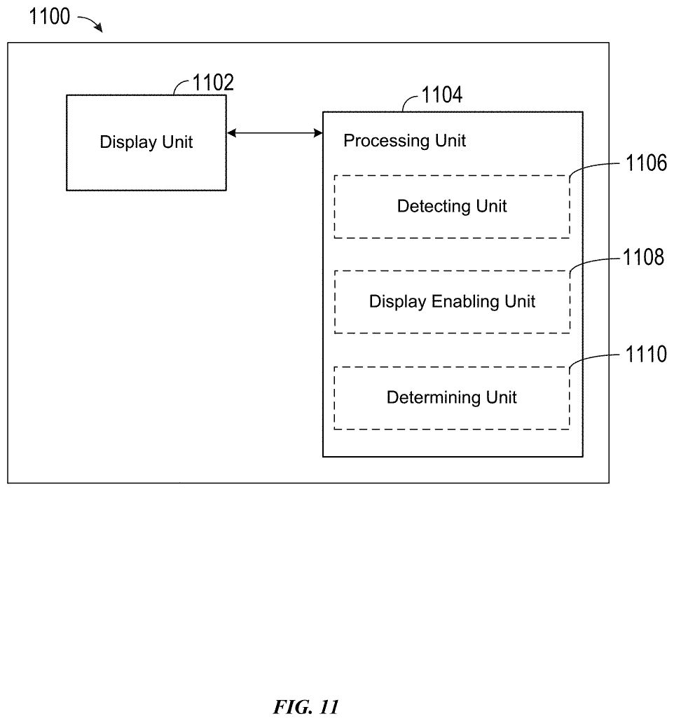

In accordance with some embodiments, FIG. 11 shows an exemplary functional block diagram of an electronic device 1100 configured in accordance with the principles of the various described embodiments. In accordance with some embodiments, the functional blocks of electronic device 1100 are configured to perform the techniques described above. The functional blocks of the device 1100 are, optionally, implemented by hardware, software, or a combination of hardware and software to carry out the principles of the various described examples. It is understood by persons of skill in the art that the functional blocks described in FIG. 11 are, optionally, combined or separated into sub-blocks to implement the principles of the various described examples. Therefore, the description herein optionally supports any possible combination or separation or further definition of the functional blocks described herein.

As shown in FIG. 11, an electronic device 1100 includes a display unit 1102 configured to display a graphic user interface and a processing unit 1104 coupled to the display unit 1102. In some embodiments, the processing unit 1104 includes a detecting unit 1106, a display enabling unit 1108, and a determining unit 1110.

The processing unit 1104 is configured to: while a user interface is displayed on the display unit, detect (e.g., with detecting unit 1106) a stationary input. Processing unit 1104 is further configured to, in response to detecting the stationary input, enable (e.g., with display enabling unit 1108) translation of one or more elements of the user interface in accordance with the stationary input. Processing unit 1104 is further configured to, after enabling translation of the one or more elements of the user interface in accordance with the stationary input, detect (e.g., with detecting unit 1106) an end of the stationary input. Processing unit 1104 is further configured to, after detecting the end of the stationary input and in accordance with a determination that the stationary input meets translation-continuation criteria, continue to enable (e.g., with display enabling unit 1108) translation of the one or more elements of the user interface.

In some embodiments, the processing unit 1104 is further configured to, after detecting the end of the stationary input and in accordance with a determination that the stationary input does not meet the translation-continuation criteria, cease to enable (e.g., with display enabling unit 1108) translation of the one or more elements of the user interface.

In some embodiments, continuing to enable translation of the one or more elements of the user interface includes causing a reduction in a speed of the translation of the one or more user interface objects over time.

In some embodiments, the processing unit 1104 is further configured to: before detecting the end of the stationary input, determine (e.g., with determining unit 1110) whether the stationary input meets translation-acceleration criteria. In accordance with a determination that the stationary input meets the translation-acceleration criteria, processing unit 1104 is optionally configured to enable (e.g., with display enabling unit 1108) acceleration of the translation of the one or more elements of the user interface over time. In accordance with a determination that the stationary input does not meet the translation-acceleration criteria, processing unit 1104 is optionally configured to continue to enable (e.g., with display enabling unit 1108) translation of the one or more elements of the user interface at the same rate over time. In some embodiments, translation of the one or more element of the user interface is accelerated smoothly from a first rate to a second rate.

In some embodiments, the translation-acceleration criteria include a criterion that is met when a duration of the stationary input exceeds a predetermined threshold. In some embodiments, the translation-continuation criteria include a criterion that is met when a duration of the stationary input exceeds a predetermined threshold.

In some embodiments, translation of the one or more elements of the user interface includes moving a cursor. In some embodiments, the cursor is moved horizontally on the display.

In some embodiments, translation of one or more elements of the user interface includes scrolling electronic content at least partially displayed on the display unit. In some embodiments, the electronic content includes an electronic document.

In some embodiments, the stationary input includes an activation of a key on a physical keyboard unit in communication with the electronic device. In some embodiments, the display unit 1102 is touch-sensitive and the stationary input includes a detected contact at a location of a virtual key on a virtual keyboard displayed on the display unit 1102.

In some embodiments, a rate of translation while detecting the stationary input is determined based on a number of sequential inputs that occurred prior to detecting the stationary input

The operations described above with reference to FIG. 10 are, optionally, implemented by components depicted in FIGS. 1A-1B or FIG. 11. For example, detecting operations 1002 and 1006 and translating operations 1004 and 1008 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

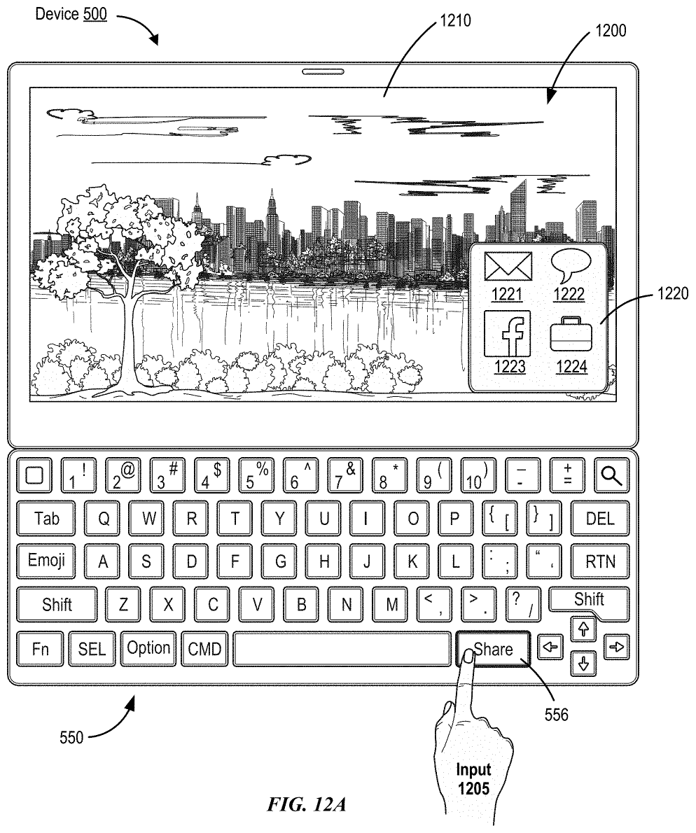

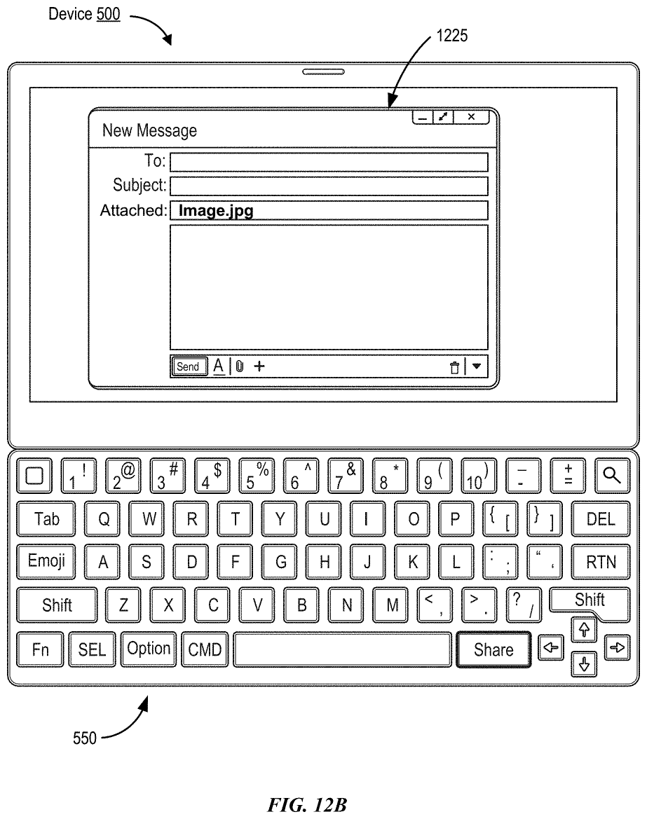

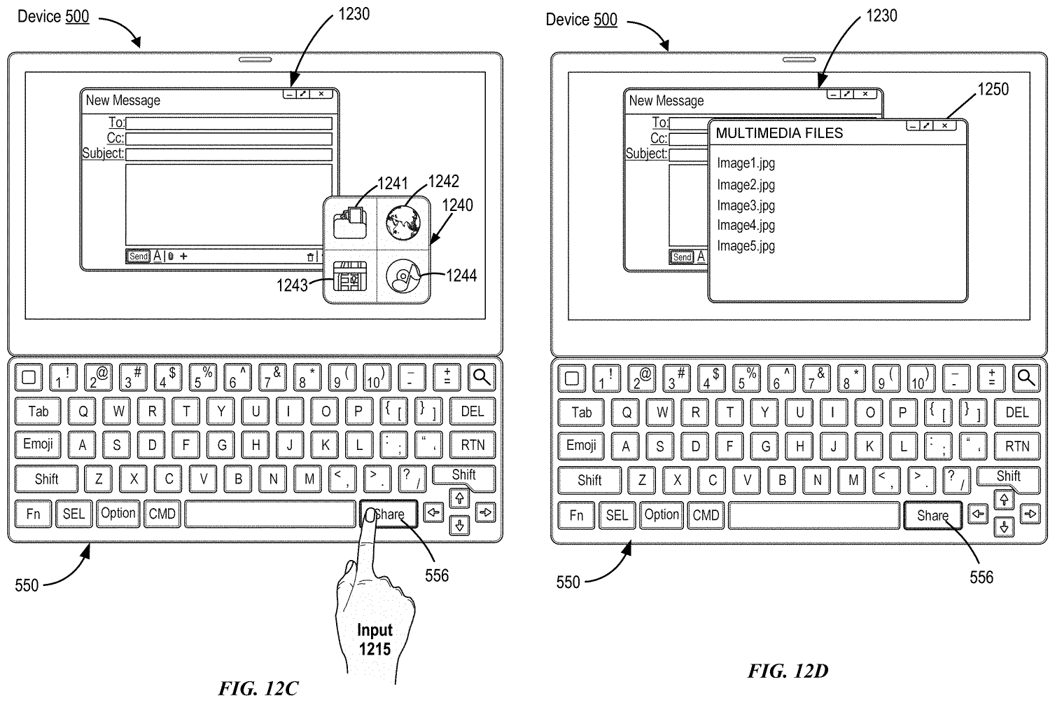

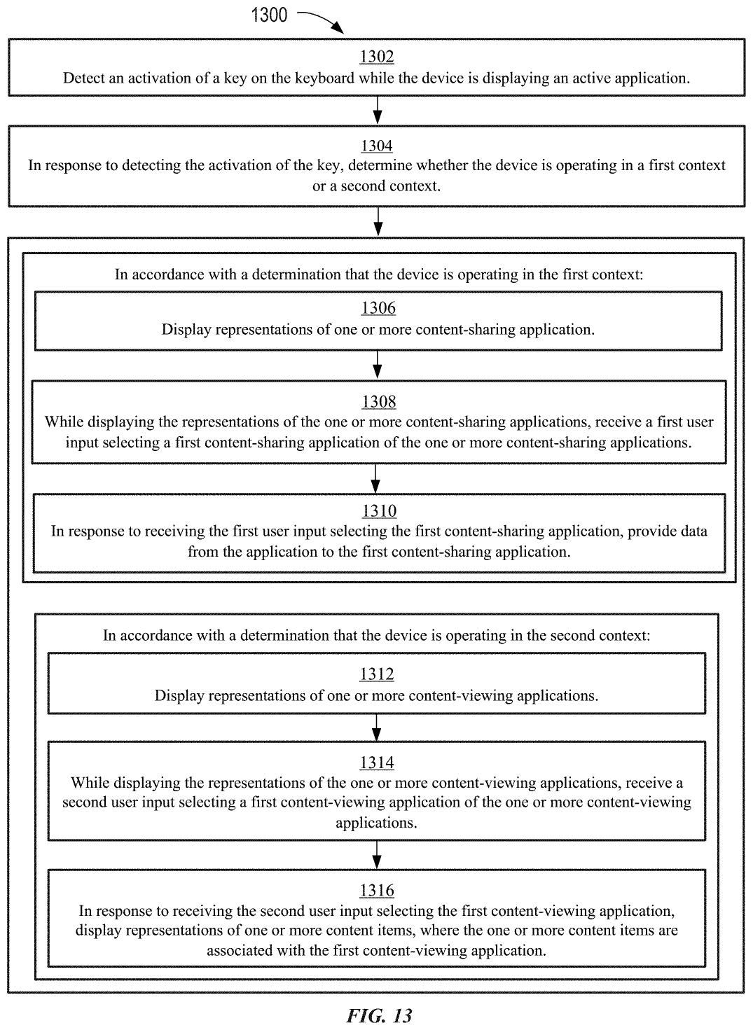

Attention is now directed to FIGS. 12A-12D, which illustrate additional embodiments of user interfaces and associated processes that may be implemented on an electronic device (e.g., 100, 300, or 500). The user interfaces in these figures are used to illustrate the processes described below, including the processes in FIG. 13.

FIG. 12A again illustrates device 500 and keyboard 550. Device 500 detects an activation of a “Share” key 556 on keyboard 550 via input 1205 while multimedia application 1200 is actively displayed on device 500. In response to detecting activation of key 556, device 500 determines the context in which device 500 is operating.

In some embodiments, a context includes a type of application (e.g., a content-viewing application, a content-sharing application, a content-creating application, a content-editing application, or a combination thereof). In the illustrated example, device 500 determines whether it is running a content-viewing application (e.g., a word processing application or a photo viewing application, such as application 1200 in FIG. 12A) or a content-creating application (e.g., a messaging application or a social networking application). In some embodiments, device 500 determines whether it is operating in one of two or more different applications.

In some embodiments, a context includes a state or operational mode of an application, operating system, or the like. Operational modes include, for example, a content viewing mode (e.g., a mode for viewing a web page in a web browser or viewing an email in an email application), a content editing mode (e.g., a mode for editing a document in a text editing application or composing an email in an email application), and an input entry mode (e.g., a mode for entering text into a text entry region to perform a search function). In some embodiments, the first and second contexts are different operational modes within the same application, operating system, or the like. In the example illustrated in FIG. 12A, multimedia application 1200 is a content-viewing application in a content viewing mode in which image 1210 is displayed.

In accordance with a determination that device 500 is operating in a first context (e.g., running content-viewing application 1200), representations of one or more content-sharing applications are displayed. FIG. 12A illustrates an exemplary user interface object 1220 including representations 1221-1224 of content-sharing applications associated with an email application, messaging application, Facebook application, and printing application, respectively.

Device 500 can receive a user input selecting one of the representations 1221-1224 of the content-sharing applications. In some embodiments, the user input is a contact on display 502 at a location corresponding to the selected representation. In some embodiments, a representation can be highlighted using the direction keys and selected by pressing the “RTN” key.

In response to receiving a selection of a representation, device 500 provides data (e.g., an image file, URL link, etc.) from content-viewing application 1200 to the content-sharing application associated with the selected representation. FIG. 12B illustrates an exemplary user interface provided in response to a selection of representation 1221 associated with an email application. In FIG. 12B, device 500 opens email application 1225 with a blank new message and provides data representing image 1210 to the email application. In some embodiments, image 1210 is automatically included as an attachment in the message.

Alternatively, in accordance with a determination that device 500 is operating in a second context, representations of one or more content-viewing applications are displayed. FIG. 12C illustrates an example in which device 500 is running a content-creating application 1230 (e.g., an email application) when “Share” key 556 is activated via input 1215. It should be recognized, however, that the second context can also be a content-sharing application, such as Facebook, Instagram, a messaging application, or the like.

In response to detecting the activation of key 556, device 500 displays a graphical user interface object 1240 including representations 1241-1244 corresponding to a file browser, internet browser, map application, and multimedia application, respectively. In response to receiving a user input selecting representation 1244 of the multimedia application, device 500 displays window 1250 including selectable representations of content items labeled Image1 thru Image 5 associated with the multimedia application. Exemplary content items include photos, videos, audio files, and the like. Device 500 receives a user input selecting one or more of the representations and, in response, provides the corresponding content item to the content-sharing or content-creating application (e.g., email application 1230). In some embodiments, the selected content item is displayed in, or added as an attachment to, the email message depicted in FIG. 12C. Content items associated with other content-viewing applications, such as a web browser, may include, for example, a website URL.

FIG. 13 is a flow diagram illustrating a method for displaying context-dependent user interfaces using an electronic device in accordance with some embodiments. Method 1300 is performed at a device (e.g., 100, 300, or 500) with a display. Some operations in method 1300 may be combined, the order of some operations may be changed, and some operations may be omitted.

As described below, method 1300 provides an intuitive way for displaying context-dependent user interfaces. The method reduces the cognitive burden on a user for accessing and sharing electronic content, thereby creating a more efficient human-machine interface. For battery-operated computing devices, enabling a user to access and share electronic content faster and more efficiently conserves power and increases the time between battery charges.

At block 1302, an activation (e.g., input 1205) of a key (e.g., key 556) on the keyboard (e.g., 550) is detected while the device is displaying an active application (e.g., multimedia application 1200).

At block 1304, in response to detecting the activation of the key, a determination is made whether the device is operating in a first context (e.g., a content-viewing application such as multimedia application 1200) or a second context (e.g., a content-sharing application such as email application 1230). In some embodiments, the first context and the second context are in the same application (e.g., a content viewing mode and a content-sharing mode of an email application, respectively). In some embodiments, the first context and the second context are in different applications.

The operations in blocks 1306, 1308, and 1310 are performed in accordance with a determination that the device is operating in the first context. At block 1306, representations of one or more content-sharing application are displayed (e.g., representations 1221-1224 in FIG. 12A). At block 1308, while displaying the representations of the one or more content-sharing applications, a first user input (e.g., input 1205) is received, where the first user input represents a selection of a first content-sharing application (e.g., an email application 1225 associated with representation 1221) of the one or more content-sharing applications. At block 1310, in response to receiving the first user input selecting the first content-sharing application, data (e.g., image 1210) is provided from the application (e.g., application 1200) to the first content-sharing application (e.g., email application 1225).

The operations in blocks 1312, 1314, and 1316 are performed in accordance with a determination that the device is operating in the second context (e.g., email application 1230). At block 1312, representations of one or more content-viewing applications are displayed (e.g., representations 1241-1244). At block 1314, while displaying the representations of the one or more content-viewing applications, a second user input (e.g., input 1215) is received, where the second user input represents a selection of a first content-viewing application (e.g., multimedia application associated with representation 1244) of the one or more content-viewing applications. At block 1316, in response to receiving the second user input selecting the first content-viewing application (e.g., input 1215), representations of one or more content items (e.g., representations Image1.jpg through Image5.jpg in window 1250) are displayed, where the one or more content items are associated with the first content-viewing application (e.g., multimedia application associated with representation 1244).

Optionally, a third user input selecting a first content item of the one or more content items is received, and in response to receiving the third user input, the first content item is provided to the second content-sharing application. In some embodiment, a representation of the first content item in the second content-sharing application is displayed in response to receiving the third user input.

Note that details of the processes described above with respect to method 1300 (e.g., FIG. 13) are also applicable in an analogous manner to the methods described below and above. For example, the inputs, outputs, interfaces, applications, keyboards, and operations described with respect to methods 700, 1000, 1600, 1900, 2200, or 2500 may include one or more of the inputs, outputs, interfaces, applications, keyboard, and operations described above with reference to method 1300.

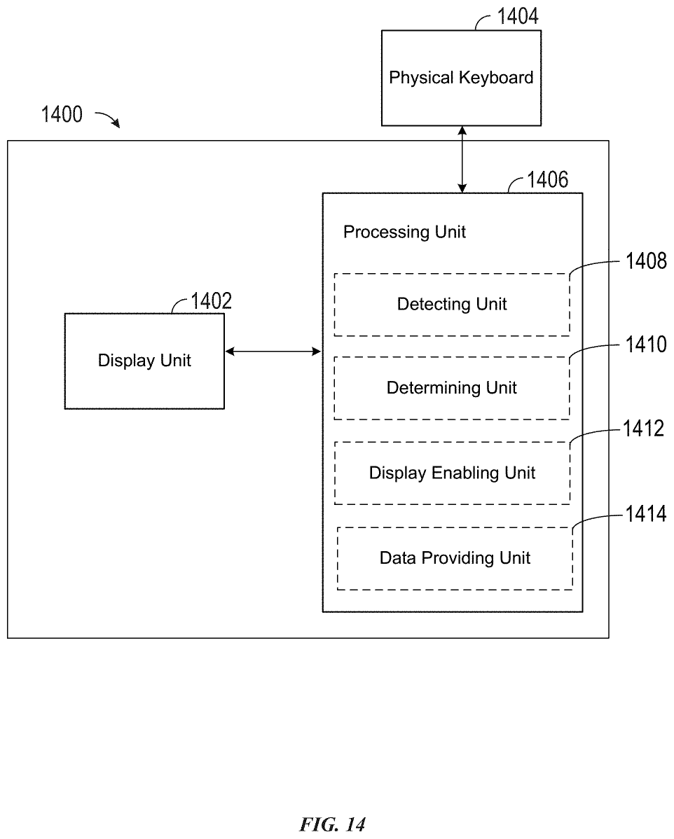

In accordance with some embodiments, FIG. 14 shows an exemplary functional block diagram of an electronic device 1400 configured in accordance with the principles of the various described embodiments. In accordance with some embodiments, the functional blocks of electronic device 1400 are configured to perform the techniques described above. The functional blocks of the device 1400 are, optionally, implemented by hardware, software, or a combination of hardware and software to carry out the principles of the various described examples. It is understood by persons of skill in the art that the functional blocks described in FIG. 14 are, optionally, combined or separated into sub-blocks to implement the principles of the various described examples. Therefore, the description herein optionally supports any possible combination or separation or further definition of the functional blocks described herein.

As shown in FIG. 14, an electronic device 1400 includes a display unit 1402 configured to display a graphic user interface and a processing unit 1406 coupled to the display unit 1402 and in communication with a physical keyboard 1404. In some embodiments, the processing unit 1406 includes a detecting unit 1408, a determining unit 1410, a display enabling unit 1412, and a data providing unit 1414.

The processing unit 1406 is configured to: detect (e.g., with detecting unit 1408), while the display unit is displaying an active application, an activation of a key on the keyboard. In response to detecting the activation of the key, processing unit 1406 is configured to determine (e.g., with determining unit 1410) whether the device is operating in a first context or a second context. In accordance with a determination that the device is operating in the first context, processing unit 1406 is configured to enable (e.g., with display enabling unit 1412) display of representations of one or more content-sharing application on the display unit, and, while the representations of the one or more content-sharing applications are displayed, detect (e.g., with detecting unit 1408) a first user input selecting a first content-sharing application of the one or more content-sharing applications. In response to detecting the first user input selecting the first content-sharing application, the processing unit 1406 is configured to: provide (e.g., with data providing unit 1414) data from the application to the first content-sharing application; and, in accordance with a determination that the device is operating in the second context: enable (e.g., with display enabling unit 1412) display of representations of one or more content-viewing applications on the display unit, and, while the representations of the one or more content-viewing applications are displayed, detect (e.g., with detecting unit 1408) a second user input selecting a first content-viewing application of the one or more content-viewing applications. In response to detecting the second user input selecting the first content-viewing application, processing unit 1406 is further configured to enable (e.g., with display enabling unit 1412) display of representations of one or more content items on the display unit, where the one or more content items are associated with the first content-viewing application.

In some embodiments, the processing unit 1406 is further configured to detect (e.g., with detecting unit 1408) a third user input selecting a first content item of the one or more content items, and, in response to receiving the third user input, provide (e.g., with data providing unit 1414) the first content item to the second content-sharing application.

In some embodiments, the processing unit 1406 is further configured to, in response to receiving the third user input, enable (e.g., with display enabling unit 1412) display of a representation of the first content item in the second content-sharing application.

In some embodiments, the first content item is a digital image or a website URL. In some embodiments, the first content-viewing application is a word processing application or an image viewing application. In some embodiments, the first content-sharing application is a social networking application.

In some embodiments, the first context is a second content-viewing application and the second context is a second content-sharing application. In some embodiments, the first context and the second context are in the same application. In some embodiments, the first context and the second context are in different applications.

The operations described above with reference to FIG. 13 are, optionally, implemented by components depicted in FIGS. 1A-1B or FIG. 14. For example, detecting operation 1302, determining operation 1304, displaying operations 1306, 1312 and 1316, receiving operations 1308 and 1314, and providing operation 1310 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

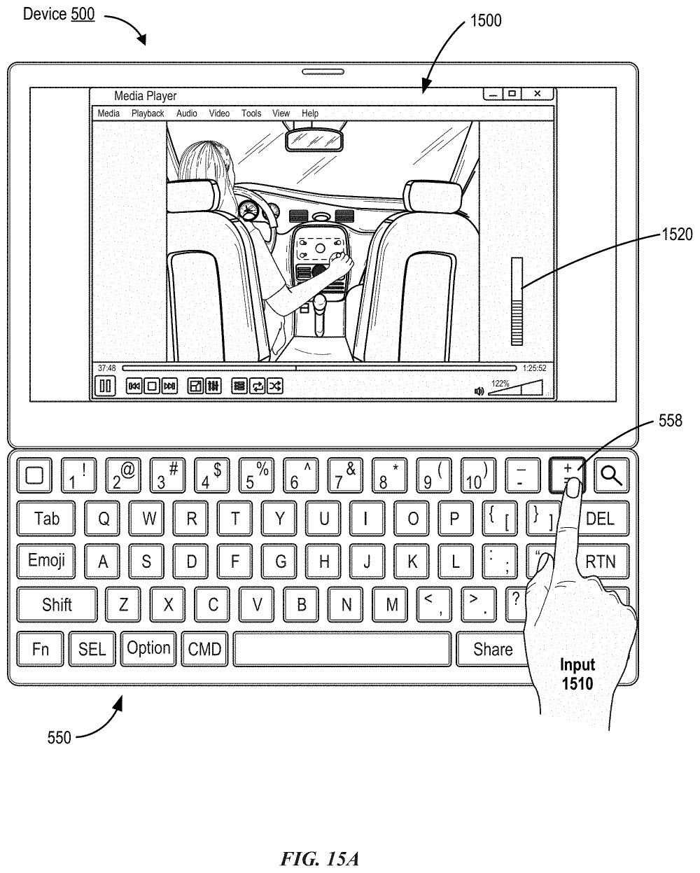

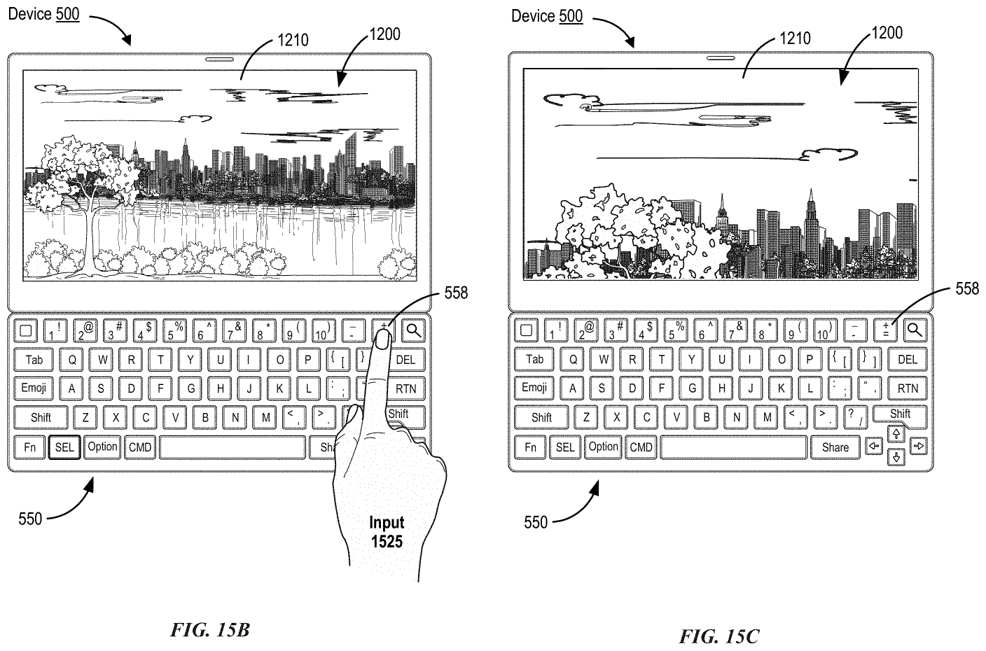

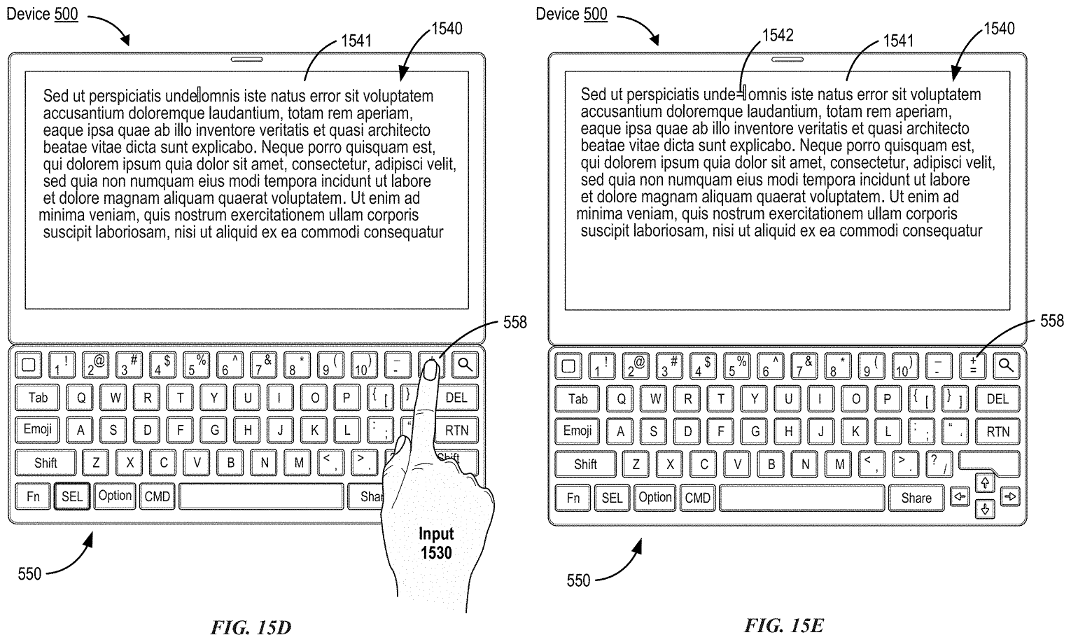

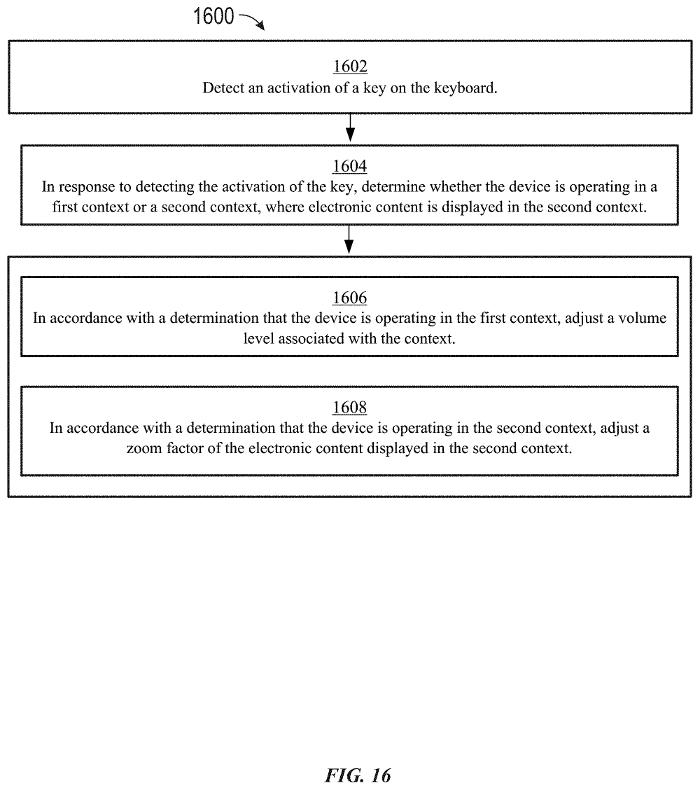

Attention is now directed to FIGS. 15A-15E, which illustrate additional embodiments of user interfaces and associated processes that may be implemented on an electronic device (e.g., 100, 300, or 500). The user interfaces in these figures are used to illustrate the processes described below, including the processes in FIG. 16.

As described above, device 500 can determine a context in which it is operating. In the example described with respect to FIGS. 15A-15C, device 500 determines whether it is operating in a context in which a home screen or springboard is displayed or whether a particular type of application is active. FIG. 15A illustrates device 500 operating in a first context and, in particular, running a multimedia player application 1500.

Device 500 detects an activation of key 558 on keyboard 550 caused by user input 1510. In response to detecting activation of key 558, and in accordance with a determination that the device 500 is running multimedia player application 1500, a volume level associated with multimedia player application 1500 is adjusted. Optionally, device 500 displays graphical user interface object 1520, which provides an indication of the current volume level.

In some embodiments, device 500 adjusts a volume setting in accordance with a determination that device 500 is operating in another context. For example, in some embodiments, device 500 determines that it is operating in a home screen context, and in response to activation of key 558, adjusts a volume setting associated with the operating system of device 500.

FIG. 15B illustrates device 500 operating in a second context and, in particular, running multimedia application 1200 in an image-viewing mode displaying electronic content image 1210. In some embodiments, the second context is another type of content-viewing application (e.g., a web browser application or map application) or content-creating application (e.g., an email application) in which electronic content is displayed.

In response to activation of key 558 by input 1525, and in accordance with a determination that the device is operating in a content-viewing context, a zoom factor of image 1210 is adjusted. FIG. 15C illustrates an exemplary display of image 1210 with an increased zoom factor.

FIG. 15D illustrates device 500 operating in a third context and, in particular, running a text editing application 1540 displaying electronic content 1541. In response to detecting activation of key 558 by input 1530, and in accordance with a determination that the device is running the text editing application 1540 in a text editing mode, character 1542 corresponding to key 558 (an “=” symbol) is inserted into the electronic content 1541, as illustrated in FIG. 15E.

FIG. 16 is a flow diagram illustrating a method for performing context-dependent operations using an electronic device in accordance with some embodiments. Method 1600 is performed at a device (e.g., 100, 300, or 500) with a display. Some operations in method 1600 may be combined, the order of some operations may be changed, and some operations may be omitted.

As described below, method 1600 provides an intuitive way for adjusting the volume or zoom factor associated with a context. The method reduces the cognitive burden on a user for adjusting the volume or zoom factor associated with a context, thereby creating a more efficient human-machine interface. For battery-operated computing devices, enabling a user to adjust the volume or zoom factor associated with a context faster and more efficiently conserves power and increases the time between battery charges.

At block 1602, an activation (e.g., input 1510) of a key (e.g., key 558) on the keyboard is detected.

At block 1604, in response to detecting the activation of the key, a determination is made whether the device is operating in a first context (e.g., running multimedia player application 1500) or a second context (e.g., displaying multimedia application 1200 in an image-viewing mode), where electronic content (e.g., image 1210) is displayed in the second context. In some embodiments, the first context is a home screen or a multimedia player application. In some embodiments, the second context is an image viewing application, a text editing application, or a web browser.

At block 1606, in accordance with a determination that the device is operating in the first context (e.g., running multimedia player application 1500), a volume level associated with the context is adjusted (e.g., FIG. 15A). Optionally, an indication of the current volume level (e.g., graphical user interface object 1520) is displayed.

At block 1608, in accordance with a determination that the device is operating in the second context (e.g., displaying multimedia application 1200 in an image-viewing mode), a zoom factor of the electronic content displayed in the second context is adjusted (e.g., FIG. 15C). Optionally, in accordance with a determination that the device is operating in a third context (e.g., text editing application 1540), a character corresponding to the key (e.g., “=”) is inserted.

Note that details of the processes described above with respect to method 1600 (e.g., FIG. 16) are also applicable in an analogous manner to the methods described below and above. For example, the inputs, outputs, interfaces, applications, keyboards, and operations described with respect to methods 700, 1000, 1300, 1900, 2200, or 2500 may include one or more of the inputs, outputs, interfaces, applications, keyboard, and operations described above with reference to method 1600.

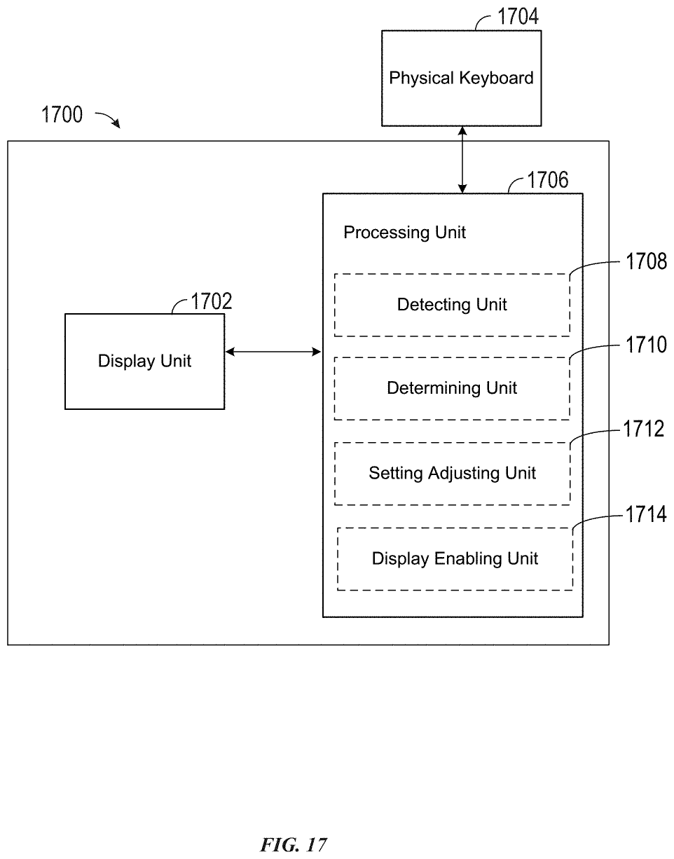

In accordance with some embodiments, FIG. 17 shows an exemplary functional block diagram of an electronic device 1700 configured in accordance with the principles of the various described embodiments. In accordance with some embodiments, the functional blocks of electronic device 1700 are configured to perform the techniques described above. The functional blocks of the device 1700 are, optionally, implemented by hardware, software, or a combination of hardware and software to carry out the principles of the various described examples. It is understood by persons of skill in the art that the functional blocks described in FIG. 17 are, optionally, combined or separated into sub-blocks to implement the principles of the various described examples. Therefore, the description herein optionally supports any possible combination or separation or further definition of the functional blocks described herein.

As shown in FIG. 17, an electronic device 1700 includes a display unit 1702 configured to display a graphic user interface and a processing unit 1706 coupled to the display unit 1702 and in communication with a physical keyboard 1704. In some embodiments, the processing unit 1706 includes a detecting unit 1708, a determining unit 1710, a setting adjusting unit 1712, and a display enabling unit 1714.

The processing unit 1706 is configured to detect (e.g., with detecting unit 1708) an activation of a key on the keyboard, and, in response to detecting the activation of the key, determine (e.g., with determining unit 1710) whether the device is operating in a first context or a second context, wherein electronic content is displayed on the display unit in the second context. In accordance with a determination that the device is operating in the first context, the processing unit 1706 is configured to adjust (e.g., with setting adjusting unit 1712) a volume level associated with the context. In accordance with a determination that the device is operating in the second context, the processing unit 1706 is configured to adjust a zoom factor of the electronic content displayed in the second context.

In some embodiments, the first context is a home screen or a multimedia player application. In some embodiments, the second context is an image viewing application, a text editing application, or a web browser application.

In some embodiments, the processing unit 1706 is further configured to, in accordance with a determination that the device is operating in the first context, enable (e.g., with display enabling unit 1714) display of an indication of the current volume level.

In some embodiments, the processing unit 1706 is further configured to, in accordance with a determination that the device is operating in a third context, enable (e.g., with display enabling unit 1714) insertion of a character corresponding to the key.

The operations described above with reference to FIG. 16 are, optionally, implemented by components depicted in FIGS. 1A-1B or FIG. 17. For example, detecting operation 1602, determining operation 1604, and adjusting operations 1606 and 1608 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

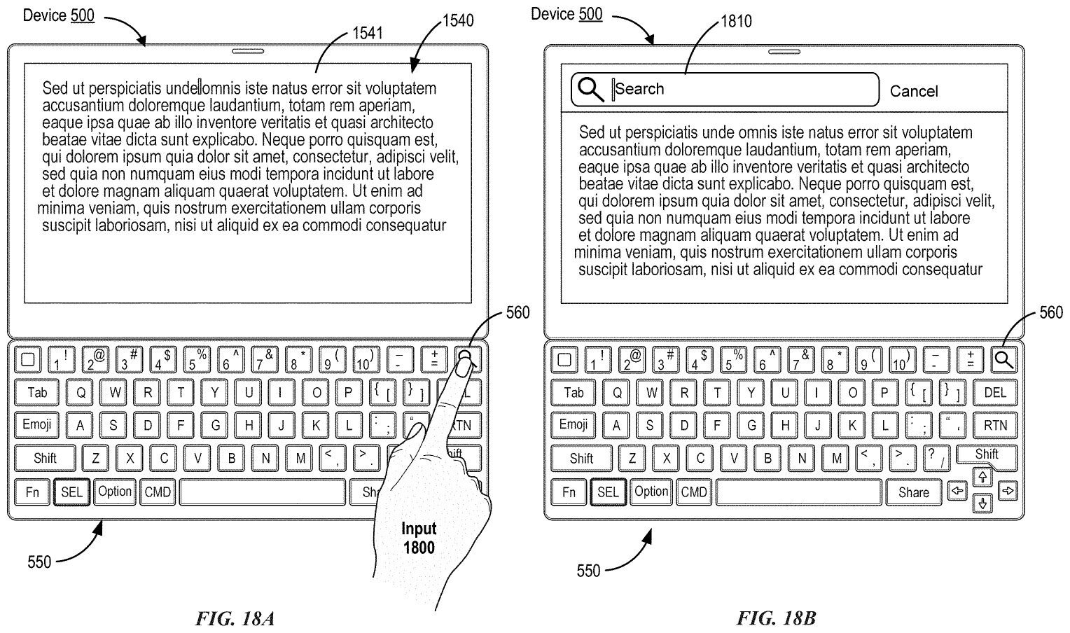

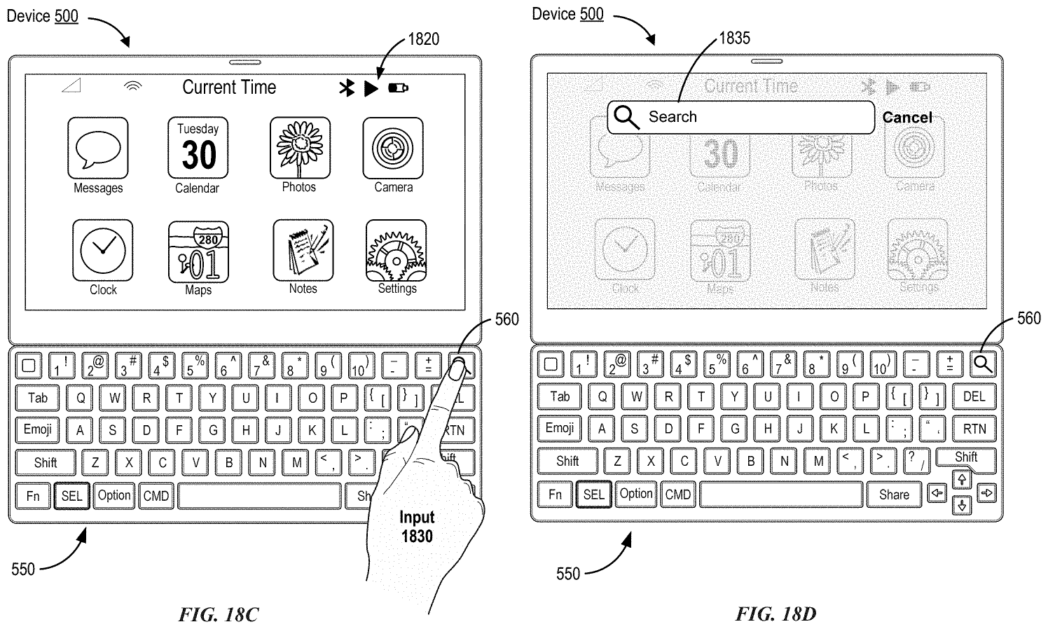

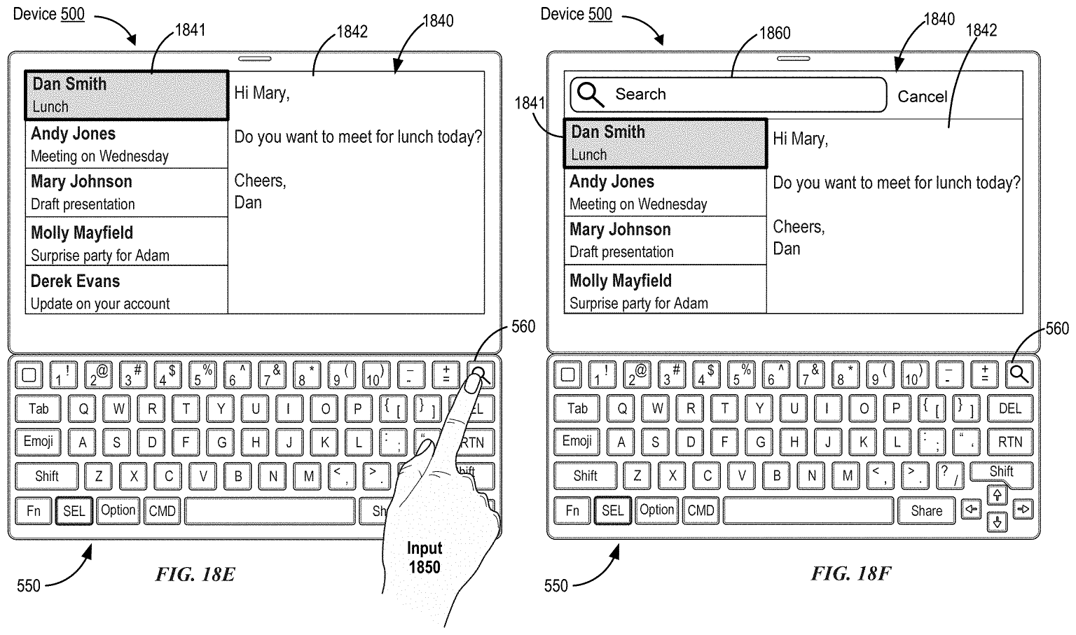

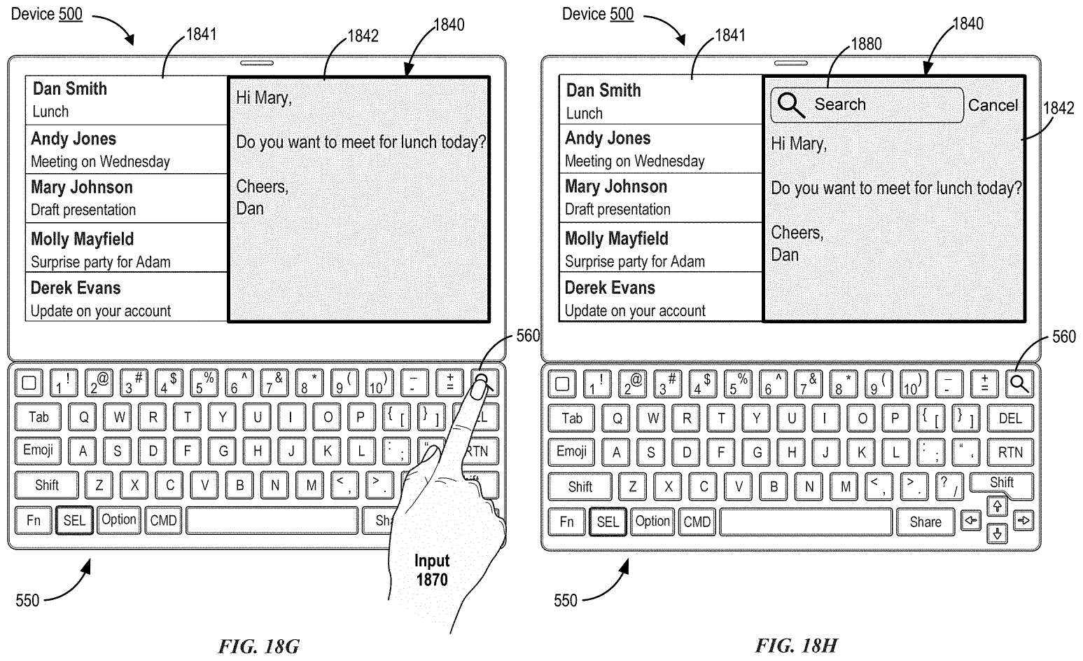

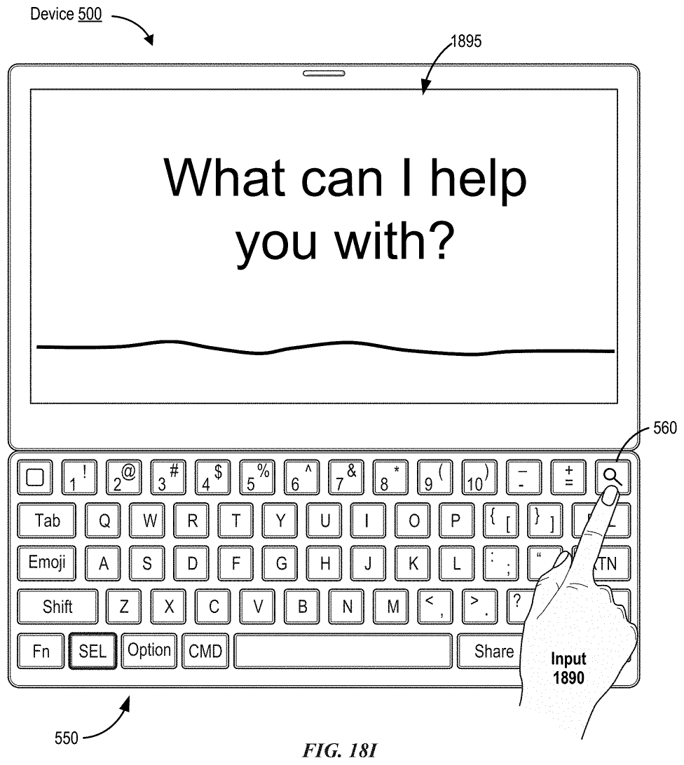

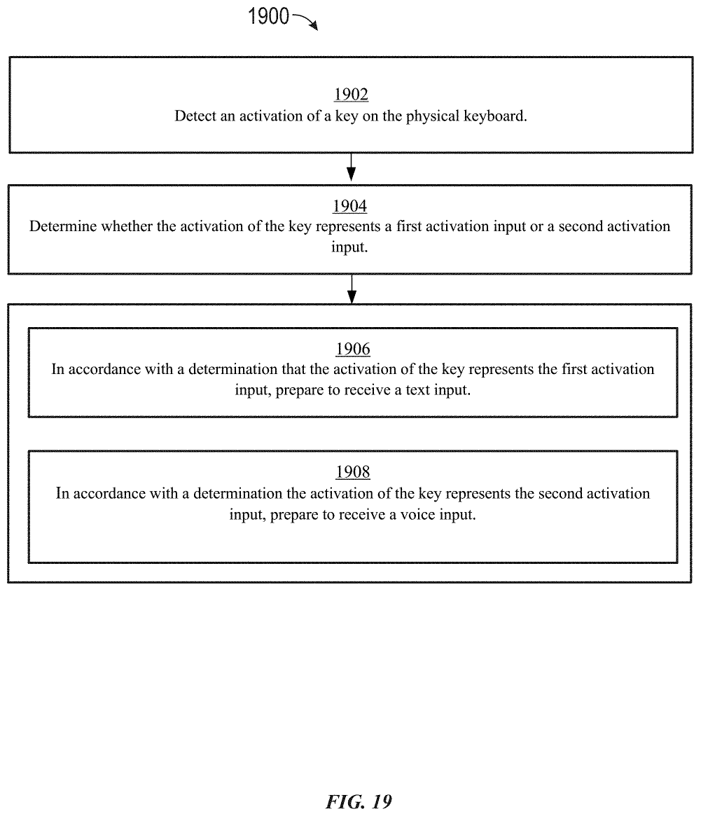

Attention is now directed to FIGS. 18A-18I, which illustrate additional embodiments of user interfaces and associated processes that may be implemented on an electronic device (e.g., 100, 300, or 500). The user interfaces in these figures are used to illustrate the processes described below, including the processes in FIG. 19.

FIG. 18A illustrates device 500 running text editing application 1540. Device 500 detects an activation of key 560 by input 1800 on keyboard 550 and determines whether the activation represents a first activation input or a second activation input. In some embodiments, a first activation input is a single press or single liftoff, and a second activation input is a double press or a press-and-hold. In some embodiments, a first activation input is a double press or a press-and-hold, and a second activation input is a single press or single liftoff.

In accordance with a determination that the activation represents a first activation input (e.g., a single press or a single liftoff), device 500 prepares to receive a text input associated with the active text editing application. In FIG. 18B, device 500 prepares to receive a text input by displaying a text search field 1810 and shifts focus to text search field 1810 for entry of text with keyboard 550. If the text search field 1810 is already displayed at the time key 560 is activated, focus is shifted to the text search field 1810. In some embodiments, text search field 1810 is associated with a search function of text editing application 1540.

In some embodiments, in accordance with a determination that device 500 is displaying a multitasking application, home screen, or application springboard, device 500 displays and/or shifts focus to a text search field associated with a search function executed by the operating system of device 500. FIG. 18C illustrates an exemplary home screen 1820 displayed on device 500. In response to a first activation input 1830 of key 560, device 500 displays text search field 1835 and de-emphasizes the graphical objects displayed on the home screen, as illustrated, for example, in FIG. 18D.

In some embodiments, the text search field is associated with a focused region of a user interface displayed on the device. For example, FIGS. 18E-18H illustrate an email application 1840 having an Inbox region 1841 and a message preview region 1842. If focus is on Inbox region 1841 when key 560 is activated (as indicated by input 1850 in FIG. 18E), then text search field 1860 is associated with a search function that searches the entire inbox (as indicated in FIG. 18F). Alternatively, if focus is on the previewed region 1842 when key 560 is activated (as indicated by input 1870 in FIG. 18G), then text search field 1880 is associated with a search function that searches only the previewed message (as indicated in FIG. 18H).

In accordance with a determination that the activation of the key represents a second activation input (e.g., multiple presses, multiple liftoffs, or a press-and-hold), device 500 prepares to receive a voice input. In some embodiments, device 500 activates an interface to a virtual assistant configured to perform a search function and prepares to detect voice inputs. FIG. 18I illustrates an exemplary graphical user interface 1895 that prompts the user to provide a voice input to the virtual assistant in response to activation of key 560 by input 1890.

In some embodiments, device 500 is configured to return to a previous state in response to further activation of key 560. In some embodiments, device 500 returns to the state it was in at the time key 560 was previously activated. In FIGS. 18A-18B, for example, device 500 may remove the display of text search field 1810 and move the cursor back to its previous location in the text 1541.

FIG. 19 is a flow diagram illustrating a method for receiving text and voice input using an electronic device in accordance with some embodiments. Method 1900 is performed at a device (e.g., 100, 300, or 500) with a display. Some operations in method 1900 may be combined, the order of some operations may be changed, and some operations may be omitted.

As described below, method 1900 provides an intuitive way for preparing a device to receive a text or voice input. The method reduces the cognitive burden on a user for preparing a device to receive a text or voice input, thereby creating a more efficient human-machine interface. For battery-operated computing devices, enabling a user to provide a text or voice input faster and more efficiently conserves power and increases the time between battery charges.

At block 1902, an activation of a key (e.g., input 1800) on a physical keyboard (e.g., 550) is detected.

At block 1904, a determination is made whether the activation of the key represents a first activation input (e.g., a single press) or a second activation input (e.g., a press-and-hold). In some embodiments, the second activation input includes a double press or a double liftoff of the key.

At block 1906, in accordance with a determination that the activation of the key represents the first activation input, the device prepares to receive a text input (e.g., display text search field 1810). In some embodiments, preparing to receive a text input includes shifting focus to a text search field or displaying a text search field (e.g., text search field 1810). Optionally, in accordance with a determination that the device is displaying an active application (e.g., text editing application 1540), the text search field is associated with a search function of the active application; and in accordance with a determination that the device is not displaying an active application (e.g., home screen 1820), the text search field is associated with a search function executed by an operating system. In some embodiments, the text search field is associated with a focused region (e.g., region 1842) of a user interface displayed on the device.

At block 1908, in accordance with a determination that the activation of the key represents the second activation input, the device prepares to receive a voice input (e.g., display user interface 1895). In some embodiments, preparing to receive a voice input includes activating an interface to a virtual assistant (e.g., interface 1895), and the virtual assistant is configured to perform a search function.

Optionally, a second activation of the key is detected, and in response to detecting the second activation of the key, the device returns to the first state (e.g., device 500 returns from the state shown in FIG. 18D to the state shown in FIG. 18C).

Note that details of the processes described above with respect to method 1900 (e.g., FIG. 19) are also applicable in an analogous manner to the methods described below and above. For example, the inputs, outputs, interfaces, applications, keyboards, and operations described with respect to methods 700, 1000, 1300, 1600, 2200, or 2500 may include one or more of the inputs, outputs, interfaces, applications, keyboard, and operations described above with reference to method 1900.

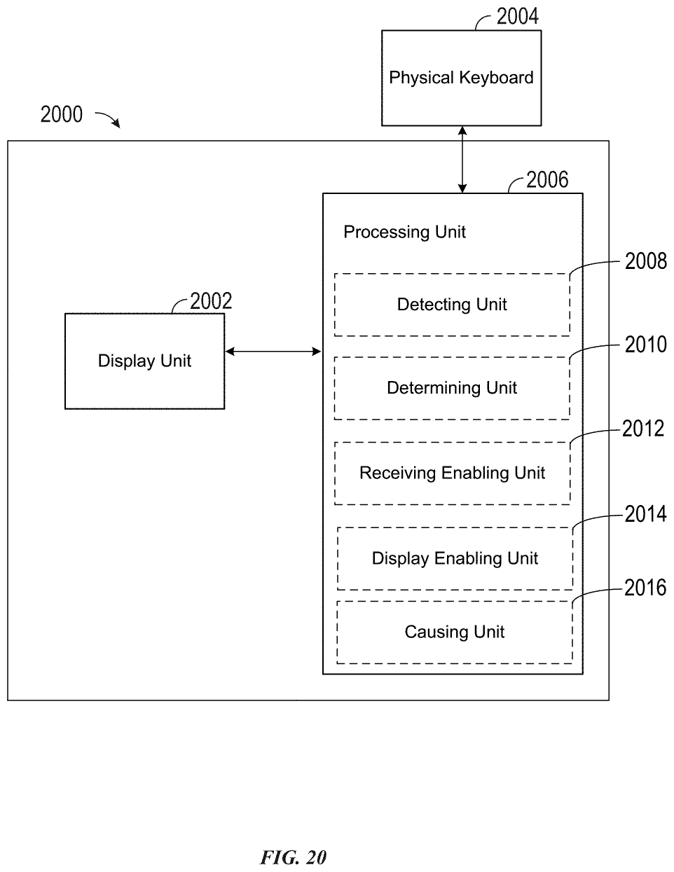

In accordance with some embodiments, FIG. 20 shows an exemplary functional block diagram of an electronic device 2000 configured in accordance with the principles of the various described embodiments. In accordance with some embodiments, the functional blocks of electronic device 2000 are configured to perform the techniques described above. The functional blocks of the device 2000 are, optionally, implemented by hardware, software, or a combination of hardware and software to carry out the principles of the various described examples. It is understood by persons of skill in the art that the functional blocks described in FIG. 20 are, optionally, combined or separated into sub-blocks to implement the principles of the various described examples. Therefore, the description herein optionally supports any possible combination or separation or further definition of the functional blocks described herein.

As shown in FIG. 20, an electronic device 2000 includes a display unit 2002 configured to display a graphic user interface and a processing unit 2006 coupled to the display unit 2002 and in communication with a physical keyboard 2004. In some embodiments, the processing unit 2006 includes a detecting unit 2008, a determining unit 2010, a receiving enabling unit 2012, a display enabling unit 2014, and a causing unit 2016.

The processing unit 2006 is configured to detect (e.g., with detecting unit 2008) an activation of a key on the physical keyboard and determine (e.g., with determining unit 2010) whether the activation of the key represents a first activation input or a second activation input. In accordance with a determination that the activation of the key represents the first activation input, processing unit 2006 is configured to enable (e.g., with receiving enabling unit 2012) receipt of a text input, and, in accordance with a determination that the activation of the key represents the second activation input, enable (e.g., with receiving enabling unit 2012) receipt of a voice input.

In some embodiments, the activation is determined to represent the first activation input when the activation includes a single press or a single liftoff of the key. In some embodiments, the activation is determined to represent the second activation input when the activation includes a double press or a double liftoff of the key. In some embodiments, the activation is determined to represent the second activation input when the activation includes a press-and-hold of the key.

In some embodiments, enabling receipt of a text input includes shifting focus to a text search field or enabling (e.g., with display enabling unit 2014) display of a text search field. In some embodiments, enabling receipt of a voice input includes activating an interface to a virtual assistant, where the virtual assistant is configured to perform a search function. In some embodiments, in accordance with a determination that the display unit is displaying an active application, the text search field is associated with a search function of the active application; and in accordance with a determination that the display unit is not displaying an active application, the text search field is associated with a search function executed by an operating system. In some embodiments, the text search field is associated with a focused region of a user interface displayed on the display unit.

In some embodiments, activation of the key is a first activation and the device is operating in a first state at the time of detection of the first activation, and the processing unit 2006 is further configured to: detect (e.g., with detecting unit 2008) a second activation of the key; and, in response to detecting the second activation of the key, cause (e.g., with causing unit 2016) the device to return to the first state.

The operations described above with reference to FIG. 19 are, optionally, implemented by components depicted in FIGS. 1A-1B or FIG. 20. For example, detecting operation 1902, determining operation 1904, and preparing operations 1906 and 1908 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

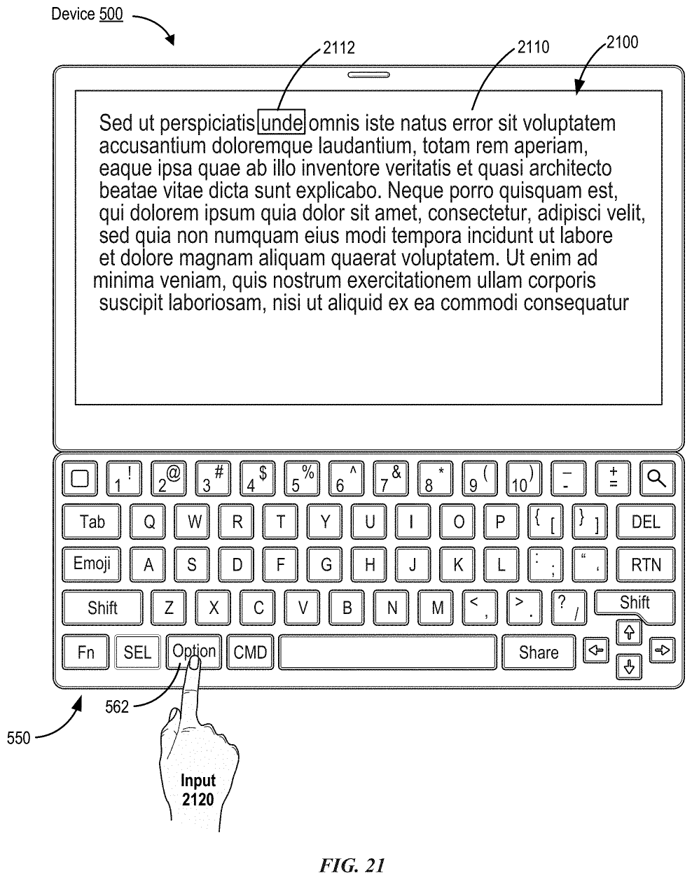

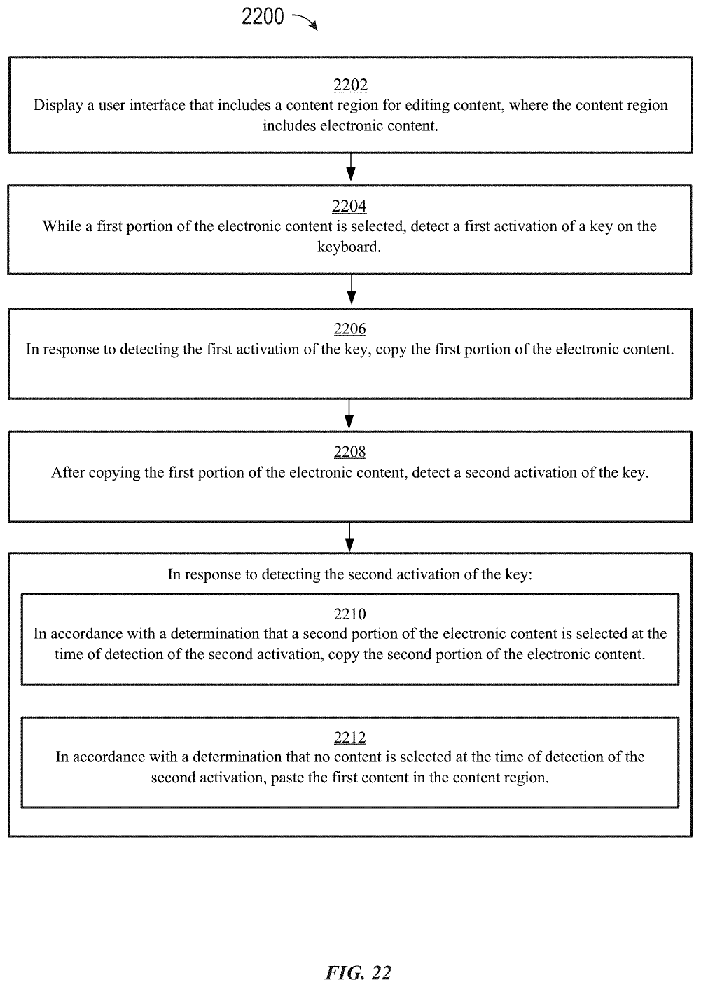

Attention is now directed to FIG. 21, which illustrates additional embodiments of user interfaces and associated processes that may be implemented on an electronic device (e.g., 100, 300, or 500). The user interface in this figure is used to illustrate the processes described below, including the processes in FIG. 22.

FIG. 21 illustrates device 500 operating in a first context, and in particular, running a text editing application. The text editing application includes a graphical user interface with a content region 2100 for editing electronic content 2110. As illustrated in FIG. 21A, electronic content 2110 includes text which is optionally editable. In some embodiments, electronic content 2110 includes images, digital objects, or other types of electronic content.

In FIG. 21, device 500 detects a first activation of key 562 by input 2120 while a first portion 2112 of the electronic content 2110 is selected. Although key 562 is labeled “Option” in FIG. 21, it should be recognized that key 562 optionally is another key, such as, for example, command key (“CMD”), or is labeled something other than the keys shown on keyboard 550 (e.g., “Copy/Paste”).

In response to detecting the activation of key 562, the first portion 2122 is copied. In some embodiments, device 500 displays an indication that the first portion 2122 has been copied. Exemplary indications that a portion of the electronic content has been copied include highlighting and/or shading the copied content, and adjusting the size, color, and/or font of the copied content.

After copying first portion 2112, a second activation of key 562 is detected. In some embodiments, the first activation and the second activation are each a single activation of key 562. In accordance with a determination that no content is selected at the time of detection of the second activation, the first portion 2112 is pasted in the content region 2100. In some embodiments, the content is pasted at a location proximate to a current insertion point. Optionally, the user interface includes a visual indication (e.g., cursor 902 illustrated in FIG. 9E) of the current insertion point. In some embodiments, in accordance with a determination that selection of the first portion 2112 has been maintained since the second activation of the key, the first portion 2112 is cut or deleted.

In some embodiments, in accordance with a determination that a second portion of the electronic content (e.g., a portion different than first portion 2112) is selected at the time the second activation of key 562 is detected, the second portion is copied in response to the second activation. After the second portion is copied, further activation of key 562 causes device 500 to operate in a similar manner as described above such that the second portion is pasted at a current insertion point if no content is selected, or a third portion is copied if the third portion is selected and is different than the second portion.

FIG. 22 is a flow diagram illustrating a method for performing copying and pasting operations using an electronic device in accordance with some embodiments. Method 2200 is performed at a device (e.g., 100, 300, or 500) with a display. Some operations in method 2200 may be combined, the order of some operations may be changed, and some operations may be omitted.

As described below, method 2200 provides an intuitive way for performing copying and pasting operations. The method reduces the cognitive burden on a user for copying and pasting electronic content, thereby creating a more efficient human-machine interface. For battery-operated computing devices, enabling a user to copy and paste faster and more efficiently conserves power and increases the time between battery charges.

At block 2202, a user interface is displayed that includes a content region (e.g., 2100) for editing content, wherein the content region includes electronic content (e.g., 2110).

At block 2204, while a first portion (e.g., 2112) of the electronic content is selected, a first activation (e.g., input 2120) of a key on the keyboard is detected.

At block 2206, in response to detecting the first activation of the key, the first portion of the electronic content is copied. Optionally, the device displays an indication that the first portion of the electric content has been copied. In some embodiments, the indication includes at least one of highlighting, shading, content size, content color, and content font.

At block 2208, after copying the first portion of the electronic content, a second activation of the key is detected. In some embodiments, the first activation and the second activation both are a single activation of the same single key.

The operations at blocks 2210 and 2212 are alternatively performed in response to detecting the second activation of the key. At block 2210, in accordance with a determination that a second portion of the electronic content is selected at the time of detection of the second activation, the second portion of the electronic content is copied. In some embodiments, in accordance with a determination that selection of the second portion of the electronic content has been maintained since detecting the second activation of the key, the second portion of the electronic content is cut. At block 2212, in accordance with a determination that no content is selected at the time of detection of the second activation, the first content is pasted in the content region.

Optionally, in response to detecting the second activation of the key, and in accordance with a determination that selection of the first portion (e.g., 2112) of the electronic content has been maintained since detecting the first activation of the key, the first portion of the electronic content is cut.

Optionally, detecting a third activation of the key is detected. In response to detecting the third activation of the key, and in accordance with a determination that a third portion of the electronic content is selected at the time of detection of the third activation, the third portion of the electronic content is copied. In accordance with a determination that no content is selected at the time of detection of the third activation, pasting the first portion or the second portion of the electronic content is pasted, where the first content is pasted if the first content was pasted in response to detecting the second activation, and the second portion of the electronic content is pasted if the second portion of the electronic content was copied in response to detecting the second activation.

In some embodiments, the user interface includes a visual indication of a current insertion point for entry of content into the content region (e.g., a cursor), and content is pasted in the content region at a location proximate to the current insertion point.

Note that details of the processes described above with respect to method 2200 (e.g., FIG. 7) are also applicable in an analogous manner to the methods described below and above. For example, the inputs, outputs, interfaces, applications, keyboards, and operations described with respect to methods 700, 1000, 1300, 1600, 1900, or 2500 may include one or more of the inputs, outputs, interface, application, keyboard, and operations described above with reference to method 2200.

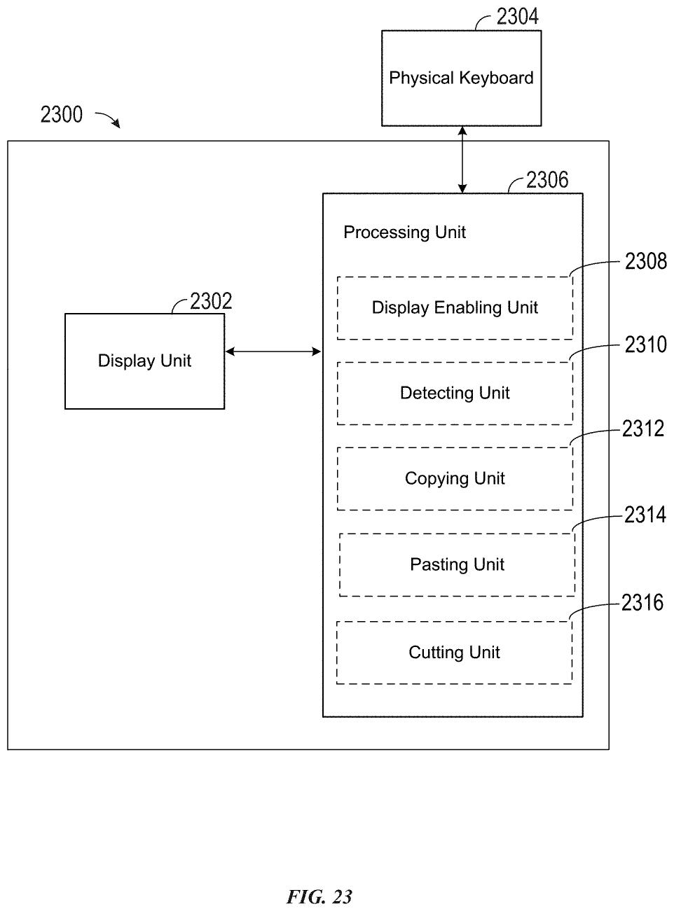

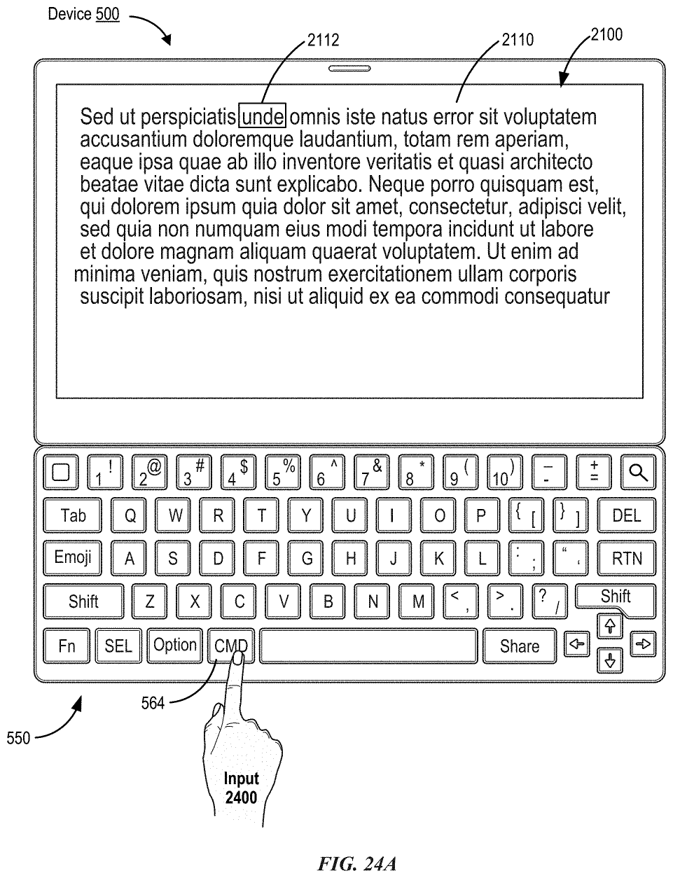

In accordance with some embodiments, FIG. 23 shows an exemplary functional block diagram of an electronic device 2300 configured in accordance with the principles of the various described embodiments. In accordance with some embodiments, the functional blocks of electronic device 2300 are configured to perform the techniques described above. The functional blocks of the device 2300 are, optionally, implemented by hardware, software, or a combination of hardware and software to carry out the principles of the various described examples. It is understood by persons of skill in the art that the functional blocks described in FIG. 23 are, optionally, combined or separated into sub-blocks to implement the principles of the various described examples. Therefore, the description herein optionally supports any possible combination or separation or further definition of the functional blocks described herein.

As shown in FIG. 23, an electronic device 2300 includes a display unit 2302 configured to display a graphic user interface and a processing unit 2306 coupled to the display unit 2302 and in communication with a physical keyboard 2304. In some embodiments, the processing unit 2306 includes a display enabling unit 2308, a detecting unit 2310, a copying unit 2312, a pasting unit 2314, and a cutting unit 2316.

The processing unit 2306 is configured to enable (e.g., with display enabling unit 2308) display of a user interface that includes a content region for editing content, where the content region includes electronic content; and, while a first portion of the electronic content is selected, detect (e.g., with detecting unit 2310) a first activation of a key on the keyboard. The processing unit 2306 is configured to, in response to detecting the first activation of the key, copy (e.g., with copying unit 2312) the first portion of the electronic content. The processing unit 2306 is further configured to: after copying the first portion of the electronic content, detect (e.g., with detecting unit 2310) a second activation of the key; and in response to detecting the second activation of the key: in accordance with a determination that a second portion of the electronic content is selected at the time of detection of the second activation, copy (e.g., with copying unit 2312) the second portion of the electronic content; and in accordance with a determination that no content is selected at the time of detection of the second activation, paste (e.g., with pasting unit 2314) the first content in the content region.

In some embodiments, the processing unit 2306 is further configured to, in response to detecting the second activation of the key and in accordance with a determination that selection of the first portion of the electronic content has been maintained since detecting the first activation of the key, cut (e.g., with cutting unit 2316) the first portion of the electronic content.

In some embodiments, the processing unit 2306 is further configured to detect (e.g., with detecting unit 2310) a third activation of the key, and, in response to detecting the third activation of the key: in accordance with a determination that a third portion of the electronic content is selected at the time of detection of the third activation, copy (e.g., with copying unit 812) the third portion of the electronic content; and in accordance with a determination that no content is selected at the time of detection of the third activation, paste (e.g., with pasting unit 814) the first portion or the second portion of the electronic content. The first content is pasted if the first content was pasted in response to detecting the second activation, and the second portion of the electronic content is pasted if the second portion of the electronic content was copied in response to detecting the second activation.

In some embodiments, the processing unit 2306 is further configured to, in response to detecting the third activation of the key and in accordance with a determination that selection of the second portion of the electronic content has been maintained since detecting the second activation of the key, cut (e.g., with cutting unit 2316) the second portion of the electronic content.

In some embodiments, the processing unit 2306 is further configured to, in response to detecting the first activation of the key, enable (e.g., with display enabling unit 2308) display of an indication that the first portion of the electric content has been copied.

In some embodiments, the indication that the first portion of the electronic content has been copied includes at least one of highlighting, shading, content size, content color, and content font.

In some embodiments, the first activation of the key is a single activation of a single key, and wherein the second activation of the key is a single activation of the same single key.

In some embodiments, the user interface includes a visual indication of a current insertion point for entry of content into the content region, and content is pasted in the content region at a location proximate to the current insertion point.

The operations described above with reference to FIG. 22 are, optionally, implemented by components depicted in FIGS. 1A-1B or FIG. 23. For example, displaying operation 2202, detecting operations 2204 and 2206, copying operations 2206 and 2210, and pasting operation 2212 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

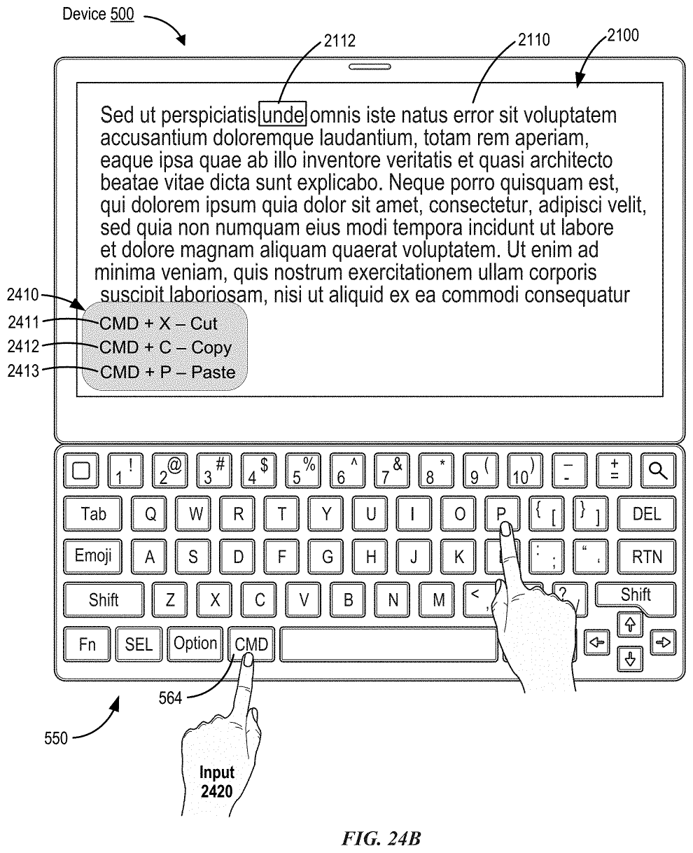

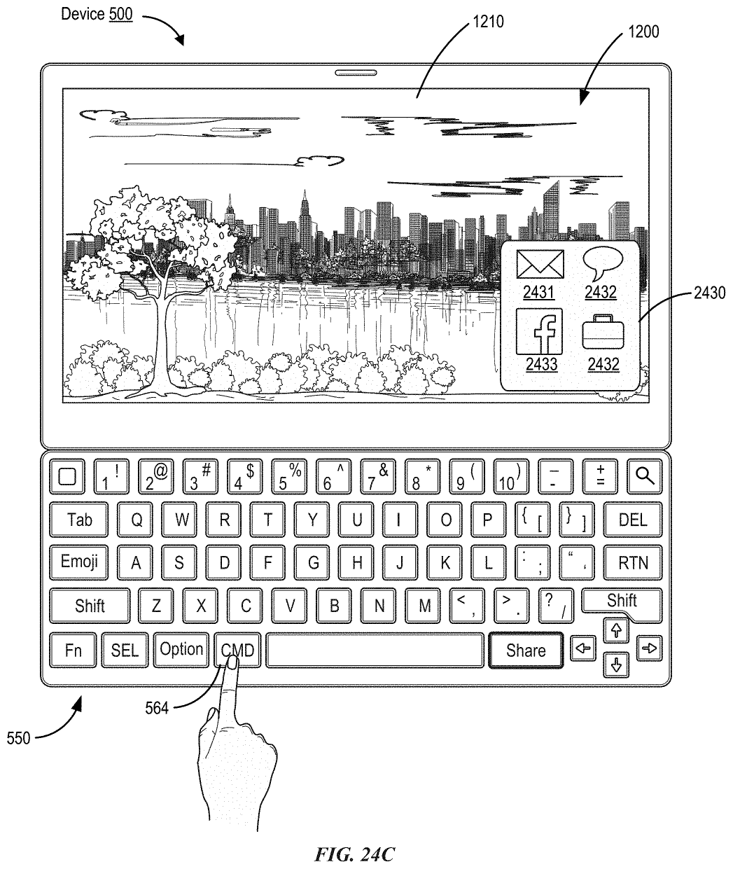

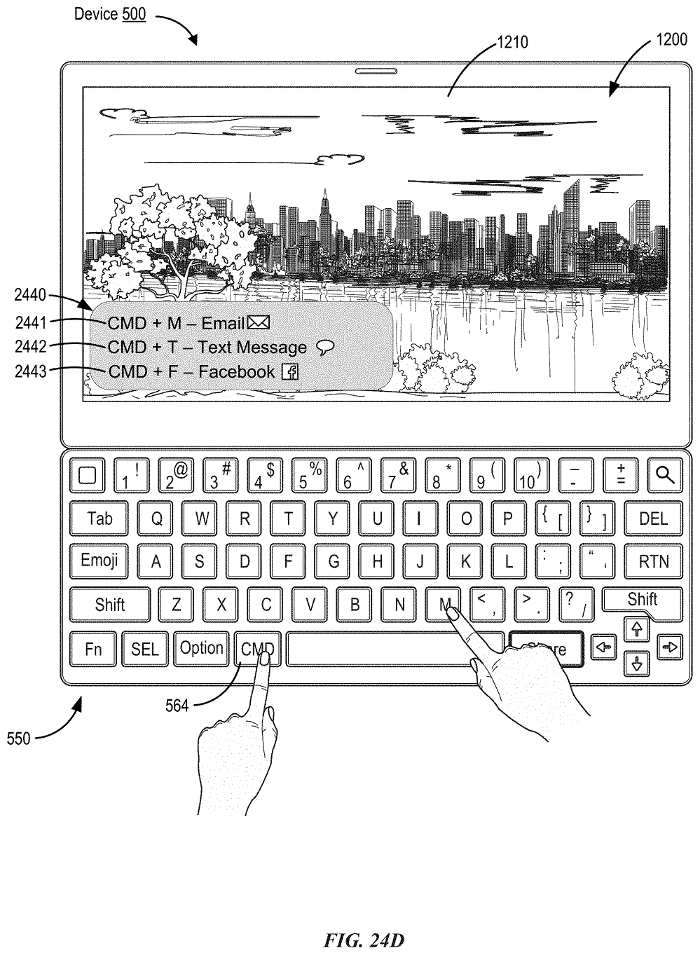

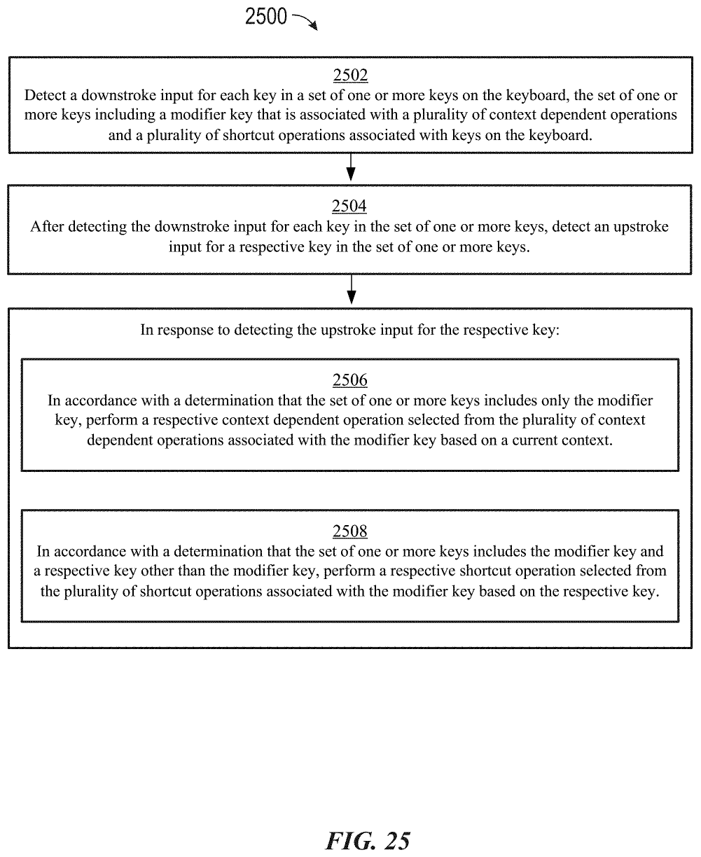

Attention is now directed to FIGS. 24A-24D, which illustrate additional embodiments of user interfaces and associated processes that may be implemented on an electronic device (e.g., 100, 300, or 500). The user interfaces in these figures are used to illustrate the processes described below, including the processes in FIG. 25.

FIG. 24A illustrates device 500 operating in a first context, and in particular, running the text editing application discussed above with reference to FIG. 21. The text editing application includes a graphical user interface with a content region 2100 for editing electronic content 2110. As illustrated in FIG. 24A, electronic content 2110 includes text which is optionally editable. In some embodiments, electronic content 2110 includes images, digital objects, or other types of electronic content.

Device 500 detects a downstroke input 2400 for a modifier key 564, labeled CMD in the illustrated embodiment. Modifier key 564 is associated with a plurality of context dependent operations. Exemplary context dependent operations include a save operation, a cut content operation, a copy content operation, and a paste content operation. Exemplary contexts in which certain operations are performed are described in greater detail below. Modifier key 564 is also associated with a plurality of shortcut operations that can be performed by activating other keys (e.g., “shortcut keys”) in combination with modifier key 564.

After detecting downstroke input 2400 for the modifier key 564, an upstroke input for modifier key 564 is detected. In response to detecting the upstroke input, device 500 performs one of the context dependent operations associated with modifier key 564 based on a current context. As mentioned above, the context illustrated in FIG. 24A includes an active text editing application with a selected portion 2112. In this context, device 500 performs a copy content operation such that the selected portion 2112 is copied in response to detecting the upstroke input for modifier key 564. In some embodiments, copied content (e.g., selected portion 2112) is stored in a virtual clipboard.

Alternatively, in some embodiments, if no text is selected and a text cursor (e.g., 902 in FIG. 9E) is placed at a location in a user interface that accepts text input (e.g., search field 1810, 1835, 1860, or 1880 or editable portion of a document (e.g., content region 2100)), a paste content operation (e.g., pasting stored content at the location of the text cursor) is performed in response to an upstroke input for modifier key 564. Notably, the context dependent operation performed when no text is selected (e.g., pasting content) is different from the operation performed when text is selected (e.g., copying content).

Alternatively, if a second portion different from portion 2112 is selected after portion 2112 has been copied, the second portion is copied and, optionally, stored in the virtual clipboard in response to detecting the upstroke input of modifier key 564.

In some embodiments, after the selected portion 2112 has been copied, it remains selected until a cursor is moved to a different location within the content region or a different portion of the content is selected. In some embodiments, in accordance with a determination that the copied portion of the electronic content has remained selected and the modifier key 564 is activated a second time (e.g., pressed and released), the selected portion is cut or deleted (e.g., a cut or delete operation is performed).

Accordingly, in some embodiments, when modifier key 564 is activated alone, without any other keys, modifier key 564 can provide functionality similar to key 562 described above with reference to FIG. 21.

In some embodiments, device 500 performs the context dependent operation only if a shortcut key is not activated between the downstroke input and the upstroke input of the modifier key 564. In some embodiments, a shortcut key can be activated by a downstroke input or an upstroke input.

FIGS. 24B-24D illustrate exemplary graphical user interfaces corresponding to detection of a downstroke input for the modifier key 564 in combination with an activation of a shortcut key prior to detection of an upstroke input for the modifier key 564 (e.g., before the modifier key 564 is released).

As illustrated in FIG. 24B, a shortcut hint user interface 2410 is optionally displayed in response to detection of a downstroke input 2420 of the modifier key 564. The shortcut hint user interface 2410 includes information identifying shortcuts of the plurality of shortcut operations associated with the modifier key 564. The information includes shortcut identifiers 2411-2413 indicating shortcut keys “X”, “C”, and “P” configured to be used with modifier key 564 to trigger corresponding shortcut operations “Cut”, “Copy”, and “Paste”, respectively.

Exemplary shortcut operations include copying selected electronic content, cutting selected electronic content, pasting electronic content, sharing content via a mode of communication (e.g., sharing a photo via email, multimedia messaging, or a social network).

In response to activation of a shortcut key while modifier key 564 is pressed (e.g., after the downstroke input and before an upstroke input), device 500 performs the shortcut operation associated with the activated shortcut key. Although the embodiment in FIG. 24B includes identifiers on shortcut hint user interface 2410, it should be recognized that in some embodiments a shortcut operation can be performed even if it is not identified on the shortcut hint user interface 2410 or even if the shortcut hint user interface 2410 is not displayed at all.

In some embodiments, the shortcut identifiers 2411-2413 for the shortcuts are independently selectable (e.g., an affordance) and a shortcut is performed in response to selection of the corresponding identifier. In some embodiments, a shortcut identifier can be selected using a cursor, selection indicator, or touch input.

In some embodiments, the shortcut hint user interface 2410 is displayed in response to a determination that the modifier key 564 has been held down for at least a predetermined amount of time (e.g., one second). In some embodiments, the shortcut hint user interface 2410 is displayed over at least a portion of a currently displayed user interface. Optionally, at least part of the shortcut hint user interface 2410 is translucent. In some embodiments, the shortcut hint user interface 2410 is displayed only if the modifier key 564 is the only key currently pressed down.

In some embodiments, the shortcut hint user interface 2410 is removed in response to activation of a shortcut key or selection of one of the shortcut identifiers 2411-2413. In some embodiments, display of the shortcut hint user interface 2410 is removed in response to detection of an upstroke input for the modifier key 564. In some embodiments in which the shortcut hint user interface 2410 is displayed after the modifier key 564 has been held down for a first predetermined amount of time, the display of the shortcut hint user interface 2410 is removed in accordance with a determination that the modifier key 564 has been held down for a second predetermined amount of time longer than the first predetermined amount of time required for display. Optionally, the shortcut hint user interface 2410 fades away or disappears before a shortcut operation is activated (e.g., by activation of a shortcut key or selection of a shortcut identifier 2111-2113).

In some embodiments, in accordance with a determination that the modifier key 564 has been held down longer than a predetermined threshold amount of time, device 500 refrains from performing a context dependent operation in response to release of the modifier key 564. For example, in the context illustrated in FIG. 24A, if the modifier key has been held down longer than a predetermined threshold amount of time, device 500 refrains from performing a copy operation of the selected portion 2112 (which would otherwise have been performed) upon release of the modifier key 564.

In some embodiments, the context dependent operations performed in response to activation of the modifier key 564 alone include at least a portion of one or more of the shortcut operations (e.g., copy or paste).

Turning to FIG. 24C, an exemplary user interface is described for when the modifier key 564 is activated while device 500 is operating in a different context than the context described above with respect to FIGS. 24A-24B. In FIG. 24C, device 500 is running and displaying a user interface of multimedia application 1200 described above with reference to FIG. 12A. The user interface includes image 1210. In some embodiments, in response to activation (e.g., pressing and releasing) of modifier key 564 without an intervening activation of a shortcut key, device 500 displays selectable options 2431-2434. Option 2431 includes the option to share the currently displayed content (e.g., image 1210) via a first mode of communication (e.g., email) and option 2432 includes the option to share the currently displayed content (e.g., image 1210) via a second mode of communication (e.g., a messaging application). Options 2433 and 2434 further include the option to share the currently displayed content via a social networking application (e.g., Facebook) and print the currently displayed content, respectively. Accordingly, in this context, modifier key 564 operates similarly to the Share key described above with respect to FIG. 12A, for example.

In some embodiments, one or more of the operations associated with options 2431-2434 can be performed in response to activation of corresponding shortcut keys while modifier key 564 is pressed. FIG. 24D illustrates exemplary shortcut hint user interface 2440, which includes shortcut identifiers 2441-2443 of exemplary shortcut operations associated with the illustrated context (e.g., a multimedia application in a content-viewing mode). Shortcut identifiers 2441-2443 represent shortcuts for sharing the image 1210 through use of an email application (shortcut CMD+M), text messaging application (shortcut CMD+T), and a social networking application (shortcut CMD+F), respectively. In some embodiments, as indicated by identifier 2441, pressing the CMD key and M key at the same time activates an email application with the image attached to a new message, as described above with reference to FIG. 12B.

As shown, the shortcuts identified in shortcut hint user interface 2440 are different than the shortcuts for the text editing application described with reference to FIG. 24B. That is, in the illustrated embodiment, the shortcut operations associated with modifier key 564 depend on the context in which device 500 is operating.

In some embodiments, keyboard 550 includes a plurality of different keys that provide functionality similar to modifier key 564 described above. In some embodiments, keyboard 550 includes a command or option modifier key with the functionality described above. In some embodiments, keyboard 550 includes a “copy/paste” modifier key with associated operations (e.g., context-dependent operations and/or context-dependent shortcut operations) that include cut, copy, and paste operations. In some embodiments, keyboard 550 includes a “Share” modifier key with associated operations that include sharing content via an email application, messaging application, or a social networking application (e.g., Twitter or Facebook). In some embodiments, keyboard 550 includes a style modifier key with associated operations that include adjusting the style or font of displayed content (e.g., bold, italic, underline, size, etc.). In some embodiments, keyboard 550 includes one or more of the modifier keys described above.

FIG. 25 is a flow diagram illustrating a method for performing context-dependent operations and shortcuts using an electronic device in accordance with some embodiments. Method 2500 is performed at a device (e.g., 100, 300, or 500) with a display. Some operations in method 2500 may be combined, the order of some operations may be changed, and some operations may be omitted.

As described below, method 2500 provides an intuitive way for performing context-dependent operations and shortcuts. The method reduces the cognitive burden on a user for performing context-dependent operations and shortcuts, thereby creating a more efficient human-machine interface. For battery-operated computing devices, enabling a user to perform context-dependent operations and shortcuts faster and more efficiently conserves power and increases the time between battery charges.

At block 2502, a downstroke input (e.g., input 2400) is detected for each key in a set of one or more keys on the keyboard. The set of one or more keys includes a modifier key (e.g., CMD key 564) that is associated with a plurality of context dependent operations and a plurality of shortcut operations associated with keys on the keyboard (e.g., keys X, C, and P). Exemplary context dependent operations include a save operation, a cut content operation, a copy content operation, and a paste content operation. In some embodiments, the context dependent operations include one or more of the shortcut operations (e.g., copy selected content). In some embodiments, the context dependent operations include one or more operations (e.g., copy selected content) that are an initial portion of one or more of the shortcut operations (e.g., copy and cut selected content).

Optionally, in response to determining that the modifier key has been held down for at least a predetermined amount of time, a shortcut hint user interface (e.g., 2410 in FIG. 24B) that includes information identifying two or more shortcuts of the plurality of shortcut operations associated with the modifier key is displayed. In some embodiments, at least part of the shortcut hint user interface is translucent. The shortcut hint user interface includes a first identifier (e.g., 2411) of a first shortcut operation (e.g., Cut) and an indication of a first key (e.g., “X”) that is configured to be used with the modifier key to trigger the first shortcut operation to be performed and a second identifier (e.g., 2412) of a second shortcut operation (e.g., Copy) and an indication of a second key (e.g., “C”) that is configured to be used with the modifier key to trigger the second shortcut operation to be performed.

In some embodiments, in accordance with a determination that the device is displaying a first active application (e.g., text editing application 2100), the first shortcut operation (e.g., 2411) and the second shortcut operation (e.g., 2412) are associated with the first active application (e.g., FIG. 24B); and in accordance with a determination that the device is displaying a second active application (e.g., multimedia application 1200), the first shortcut operation (e.g., 2441) and the second shortcut operation (e.g., 2442) are associated with the second active application (e.g., FIG. 24D).

In some embodiments, in accordance with a determination that the device is displaying an active application (e.g., multimedia application 2100) in a first context (e.g., content-editing mode), the first shortcut operation (e.g., Cut) and the second shortcut operation (e.g., Copy) are associated with the first context; and in accordance with a determination that the device is displaying the active application in a second context (content-viewing mode), the first shortcut operation (e.g., share via email) and the second shortcut operation (e.g., share via text message) are associated with the second context.

Optionally, in accordance with a determination that the modifier key has been held down for a second predetermined amount of time longer than the predetermined amount of time, the display of the shortcut hint user interface is removed.

At block 2504, after detecting the downstroke input for each key in the set of one or more keys, an upstroke input is detected for a respective key (e.g., CMD key 564 or shortcut key P) in the set of one or more keys.

The operations in blocks 2506 and 2508 are performed alternatively in response to detecting the upstroke input for the respective key. At block 2506, in accordance with a determination that the set of one or more keys includes only the modifier key (e.g., CMD key 564), a respective context dependent operation is performed (e.g., cut selected content 2112). The respective context dependent operation is selected from the plurality of context dependent operations associated with the modifier key based on a current context (e.g., displaying the text editing application associated with content region 2100). In some embodiments, in accordance with a determination that the current context is a first context (e.g., text editing application associated with content region 2100), the respective content dependent operation is a first operation (e.g., cut selected content 2112); and in accordance with a determination that the current context is a second context (e.g., multimedia application 1200) that is different from the first context, the respective content dependent operation is a second operation (e.g., display options menu 2430) that is different from the first operation.

Optionally, performing the respective context dependent operation includes displaying a plurality of selectable options (e.g., options 2431-2432 in FIG. 34C), including a first option (e.g., option 2431) to perform a first operation (e.g., share via email) and a second option (e.g., option 2432) to perform a second operation (e.g., share via text message).

Optionally, if a shortcut hint user interface is displayed, the shortcut hint user interface is removed in response to detecting the upstroke input for the respective key.

At block 2508, in accordance with a determination that the set of one or more keys includes the modifier key and a respective key other than the modifier key (e.g., shortcut key P), a respective shortcut operation is performed (e.g., paste previously copied content). The respective shortcut operation is selected from the plurality of shortcut operations associated with the modifier key based on the respective key. In some embodiments, in accordance with a determination that the respective key is a first key (e.g., shortcut key P), the respective shortcut operation is a first operation (e.g., paste previously copied content); in accordance with a determination that the respective key is a second key (e.g., shortcut key X) that is different from the first key, the respective shortcut operation is a second operation (e.g., cut currently selected content) that is different from the first operation; and in accordance with a determination that the respective key is a third key (e.g., shortcut key C) that is different from the first key, the respective shortcut operation is a third operation (e.g., copy currently selected content) that is different from the first operation and the second operation.

Note that details of the processes described above with respect to method 2500 (e.g., FIG. 25) are also applicable in an analogous manner to the methods described above. For example, the inputs, outputs, interfaces, applications, keyboards, and operations described with respect to methods 700, 1000, 1300, 1600, 1900, and 2200 may include one or more of the inputs, outputs, interfaces, applications, keyboard, and operations described above with reference to method 2500.

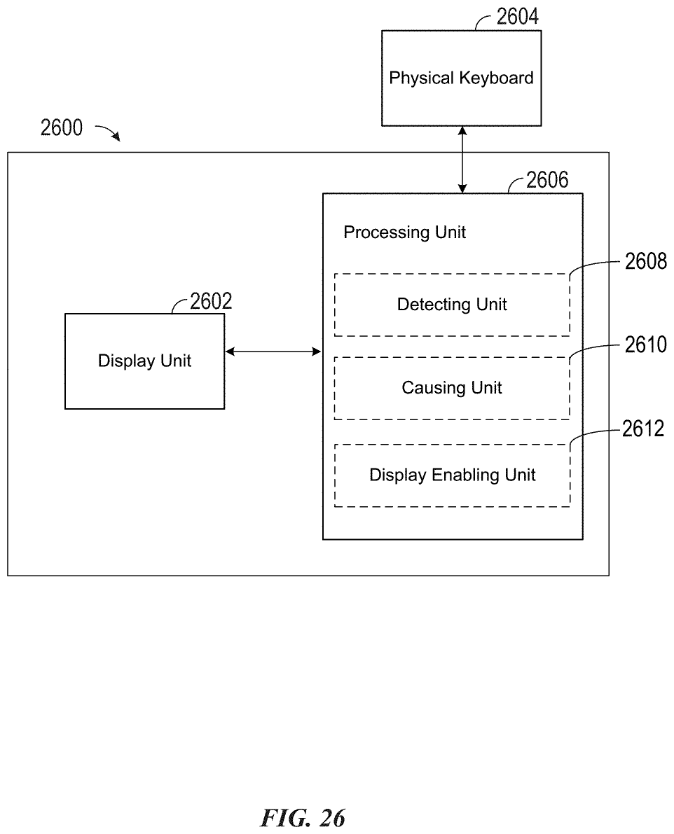

In accordance with some embodiments, FIG. 26 shows an exemplary functional block diagram of an electronic device 2600 configured in accordance with the principles of the various described embodiments. In accordance with some embodiments, the functional blocks of electronic device 2600 are configured to perform the techniques described above. The functional blocks of the device 2600 are, optionally, implemented by hardware, software, or a combination of hardware and software to carry out the principles of the various described examples. It is understood by persons of skill in the art that the functional blocks described in FIG. 26 are, optionally, combined or separated into sub-blocks to implement the principles of the various described examples. Therefore, the description herein optionally supports any possible combination or separation or further definition of the functional blocks described herein.

As shown in FIG. 26, an electronic device 2600 includes a display unit 2602 configured to display a graphic user interface and a processing unit 2606 coupled to the display unit 2602 and in communication with a physical keyboard. In some embodiments, the processing unit 2606 includes a detecting unit 2608, a causing unit 2610, and a display enabling unit 2612.

The processing unit 2606 is configured to detect (e.g., with detecting unit 2608) a downstroke input for each key in a set of one or more keys on the keyboard, the set of one or more keys including a modifier key that is associated with a plurality of context dependent operations and a plurality of shortcut operations associated with keys on the keyboard. Processing unit 2606 is further configured to, after detecting the downstroke input for each key in the set of one or more keys, detect (e.g., with detecting unit 2608) an upstroke input for a respective key in the set of one or more keys. In response to detecting the upstroke input for the respective key, processing unit 2606 is configured to: in accordance with a determination that the set of one or more keys includes only the modifier key, cause (e.g., with causing unit 2610) a respective context dependent operation selected from the plurality of context dependent operations associated with the modifier key based on a current context; and in accordance with a determination that the set of one or more keys includes the modifier key and a respective key other than the modifier key, cause (e.g., with causing unit 2610) a respective shortcut operation selected from the plurality of shortcut operations associated with the modifier key based on the respective key.

In some embodiments, causing the respective context dependent operation selected from the plurality of context dependent operations associated with the modifier key based on the current context includes: in accordance with a determination that the current context is a first context, the respective content dependent operation is a first operation; and in accordance with a determination that the current context is a second context that is different from the first context, the respective content dependent operation is a second operation that is different from the first operation.

In some embodiments, causing the respective shortcut operation selected from the plurality of shortcut operations associated with the modifier key based on the respective key includes: in accordance with a determination that the respective key is a first key, the respective shortcut operation is a first operation; and in accordance with a determination that the respective key is a second key that is different from the first key, the respective shortcut operation is a second operation that is different from the first operation.

In some embodiments, causing the respective shortcut operation selected from the plurality of shortcut operations associated with the modifier key based on the respective key includes: in accordance with a determination that the respective key is a third key that is different from the first key, the respective shortcut operation is a third operation that is different from the first operation and the second operation.

In some embodiments, the context dependent operations include one or more of the shortcut operations. In some embodiments, the context dependent operations include one or more operations that are an initial portion of one or more of the shortcut operations.

In some embodiments, causing the respective context dependent operation selected from the plurality of context dependent operations associated with the modifier key based on the current context includes enabling (e.g., with display enabling unit 2612) display of a plurality of selectable options, including a first option to perform a first operation and a second option to perform a second operation. In some embodiments, causing the respective shortcut operation selected from the plurality of shortcut operations associated with the modifier key based on the respective key includes: in accordance with a determination that the respective key is a first key, the respective shortcut operation is the first operation; and in accordance with a determination that the respective key is a second key that is different from the first key, the respective shortcut operation is the second operation.

In some embodiments, the processing unit 2606 is further configured to, after detecting the downstroke operation for the modifier key and before detecting the upstroke input for the respective key: detect (e.g., with detecting unit 2608) that the modifier key has been held down for at least a predetermined amount of time; and in response to determining that the modifier key has been held down for at least the predetermined amount of time, enable (e.g., with display enabling unit 2612) display of a shortcut hint user interface that includes information identifying two or more shortcuts of the plurality of shortcut operations associated with the modifier key, including: a first identifier of a first shortcut operation and an indication of a first key that is configured to be used with the modifier key to trigger the first shortcut operation to be performed; and a second identifier of a second shortcut operation and an indication of a second key that is configured to be used with the modifier key to trigger the second shortcut operation to be performed.

In some embodiments, in accordance with a determination that the display unit is displaying a first active application, the first shortcut operation and the second shortcut operation are associated with the first active application, and in accordance with a determination that the display unit is displaying a second active application, the first shortcut operation and the second shortcut operation are associated with the second active application.

In some embodiments, in accordance with a determination that the display unit is displaying an active application in a first context, the first shortcut operation and the second shortcut operation are associated with the first context, and in accordance with a determination that the display unit is displaying an active application in a second context, the first shortcut operation and the second shortcut operation are associated with the second context.

In some embodiments, the processing unit 2606 is further configured to, in accordance with a determination that the modifier key has been held down for a second predetermined amount of time longer than the predetermined amount of time, enable (e.g., with display enabling unit 2612) removal of the display of the shortcut hint user interface.

In some embodiments, the processing unit 2606 is further configured to, in response to detecting the upstroke input for the respective key, enable (e.g., with display enabling unit 2612) removal of the display of the shortcut hint user interface. In some embodiments, at least part of the shortcut hint user interface is translucent.

In some embodiments, the respective context dependent operation is one of a save operation, a cut content operation, a copy content operation, and a paste content operation.

The operations described above with reference to FIG. 25 are, optionally, implemented by components depicted in FIGS. 1A-1B or FIG. 26. For example, detecting operations 2502 and 2504, and performing operations 2506 and 2508 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub event, such as activation of an affordance on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. An electronic device in communication with a physical keyboard, the electronic device comprising:
a display;
one or more processors;
a memory; and
one or more programs, wherein the one or more programs are stored in the memory and configured to be executed by the one or more processors, the one or more programs including instructions for:
detecting a downstroke input for each key in a set of one or more keys on the keyboard, the set of one or more keys including a modifier key that is associated with a plurality of context dependent operations and a plurality of shortcut operations associated with keys on the keyboard; and
after detecting the downstroke input for each key in the set of one or more keys:
in accordance with a determination that the set of one or more keys includes only the modifier key, displaying a shortcut hint user interface, wherein the shortcut hint user interface includes information identifying two or more shortcut operations associated with the modifier key, the shortcut hint user interface including:
a first identifier of a first shortcut operation and an indication of a first key that is configured to be used with the modifier key to trigger the first shortcut operation to be performed; and
a second identifier of a second shortcut operation and an indication of a second key that is configured to be used with the modifier key to trigger the second shortcut operation to be performed; and
in accordance with a determination that the set of one or more keys includes the modifier key and a respective key other than the modifier key, performing a respective shortcut operation selected from the plurality of shortcut operations associated with the modifier key based on the respective key.

2. The electronic device of claim 1, wherein the one or more programs further include instructions for:
detecting that the modifier key has been held down for at least a predetermined amount of time, wherein displaying the shortcut hint user interface occurs in response to determining that the modifier key has been held down for at least the predetermined amount of time.

3. The electronic device of claim 1, wherein the one or more programs further include instructions for:
detecting user input; and
in response to detecting the user input:
in accordance with a determination that the user input corresponds to selection of the first identifier, performing the first shortcut operation; and
in accordance with a determination that the user input corresponds to selection of the second identifier, performing the second shortcut operation.

4. The electronic device of claim 3, wherein the one or more programs further include instructions for:
in accordance with a determination that the user input corresponds to selection of either the first identifier or the second identifier, removing the display of the shortcut hint user interface.

5. The electronic device of claim 1, wherein the one or more programs further include instructions for:
after detecting the downstroke input for each key in the set of one or more keys, detecting an upstroke input for the respective key;
in response to detecting the upstroke input for the respective key, removing the display of the shortcut hint user interface.

6. The electronic device of claim 1, wherein the one or more programs further include instructions for:
after detecting the downstroke input for each key in the set of one or more keys, detecting an upstroke input for the respective key, wherein the respective shortcut operation is performed after detecting the upstroke input for the respective key.

7. The electronic device of claim 1, wherein:
in accordance with a determination that the device is displaying a first active application, the respective shortcut operation is a first operation; and
in accordance with a determination that the device is displaying a second active application different from the first active application, the respective shortcut operation is a second operation different from the first operation.

8. The electronic device of claim 1, wherein the shortcut hint user interface is displayed over at least a portion of a currently displayed user interface.

9. The electronic device of claim 1, wherein:
in accordance with a determination that the device is displaying a first active application, the first shortcut operation is associated with the first active application; and
in accordance with a determination that the device is displaying a second active application different from the first active application, the first shortcut operation is associated with the second active application.

10. A method, comprising:
at a device with a display and in communication with a physical keyboard:
detecting a downstroke input for each key in a set of one or more keys on the keyboard, the set of one or more keys including a modifier key that is associated with a plurality of context dependent operations and a plurality of shortcut operations associated with keys on the keyboard; and
after detecting the downstroke input for each key in the set of one or more keys:
in accordance with a determination that the set of one or more keys includes only the modifier key, displaying a shortcut hint user interface, wherein the shortcut hint user interface includes information identifying two or more shortcut operations associated with the modifier key, the shortcut hint user interface including:
a first identifier of a first shortcut operation and an indication of a first key that is configured to be used with the modifier key to trigger the first shortcut operation to be performed; and
a second identifier of a second shortcut operation and an indication of a second key that is configured to be used with the modifier key to trigger the second shortcut operation to be performed; and
in accordance with a determination that the set of one or more keys includes the modifier key and a respective key other than the modifier key, performing a respective shortcut operation selected from the plurality of shortcut operations associated with the modifier key based on the respective key.

11. A non-transitory computer readable storage medium storing one or more programs, the one or more programs comprising instructions, which when executed by one or more processors of an electronic device with a display and in communication with a physical keyboard, cause the device to:
detect a downstroke input for each key in a set of one or more keys on the keyboard, the set of one or more keys including a modifier key that is associated with a plurality of context dependent operations and a plurality of shortcut operations associated with keys on the keyboard; and
after detecting the downstroke input for each key in the set of one or more keys:
in accordance with a determination that the set of one or more keys includes only the modifier key, display a shortcut hint user interface, wherein the shortcut hint user interface includes information identifying two or more shortcut operations associated with the modifier key, the shortcut hint user interface including:
a first identifier of a first shortcut operation and an indication of a first key that is configured to be used with the modifier key to trigger the first shortcut operation to be performed; and
a second identifier of a second shortcut operation and an indication of a second key that is configured to be used with the modifier key to trigger the second shortcut operation to be performed; and
in accordance with a determination that the set of one or more keys includes the modifier key and a respective key other than the modifier key, perform a respective shortcut operation selected from the plurality of shortcut operations associated with the modifier key based on the respective key.
